(19) United States
(12) Patent Application Publication
(10) Pub. No.: US 2003/0012411 A1
(43) Pub. Date: Jan. 16, 2003

(54) System and method for displaying and collecting ground penetrating radar data

(76) Inventors: Keith Jerome Sjostrom, Des Moines, IA (US); Gary Neal Young, El Paso, TX (US)

Correspondence Address: CRAWFORD PLLC, 1270 Northland Drive, Suite 390, St. Paul, MN, 55120, US

(21) Appl. No.: 10/195,856

(22) Filed: Jul. 15, 2002

Related U.S. Application Data
(60) Provisional application No. 60/305,295, filed on Jul. 13, 2001.

(51) Int. Cl. G06K 9/00

(52) U.S. Cl. 382/109

(57) ABSTRACT

A system and method of detecting underground utilities and other subsurface objects involves acquiring object location data and displaying such data in a variety of ways to enhance object detection and usability of ground penetrating radar data.

### RELATED APPLICATIONS

This application claims the benefit of U.S. Provisional Application No. 60/305,295 filed Jul. 13, 2001, which is hereby incorporated by reference in its entirety.

### FIELD OF THE INVENTION

The present invention relates generally to the field of underground utility and object detection, and, more particularly, to systems and methods of collecting and displaying object detection data acquired by a ground penetrating radar (GPR) system.

### BACKGROUND OF THE INVENTION

Various techniques have been developed to detect and locate underground utilities and other manmade or natural subsurface structures. It is readily appreciated that before trenching, boring, or otherwise engaging in invasive subsurface activity to install or access utilities, it is imperative to know the location of any existing utilities and/or obstructions in order to assist in trenching or boring operations and minimize safety risks. Currently, utilities that are installed or otherwise discovered during installation may have their corresponding physical locations manually recorded in order to facilitate future installations. One such system is referred to as the One-Call system, where an inquiry call can be made to obtain utility location information from an organization that manually records utility location information, when and if it is provided. However, the One-Call system is not particularly reliable, as only a certain percentage of the utilities are recorded, and those that are recorded may have suspect or imprecise location data. As such, currently-existing location data for buried utilities is incomplete and often questionable in terms of reliability.

One known utility detection technique involves the use of ground penetrating radar. GPR, in general, is a very good sensor for utility detection purposes, in that GPR is easy to use and provides excellent resolution. Conventional GPR systems are typically used to collect single profiles of object detection data that are subsequently viewed by the operator. The operator, through manual effort, typically interprets the data record in order to detect buried features. The operator then marks the ground above such detected features with some form of visually perceivable marking.

In order to take advantage of more advanced signal processing features, the GPR data acquired by the GPR sensing system must be transferred into another separate data analysis software program and/or ported to another computer system. Such advanced data processing tools are typically usable by only the more sophisticated user. The operator of the GPR sensing system, therefore, is provided with only modest functionality for processing GPR data and has little opportunity to actively assist in enhancing the object detection process.

There is a need in the object detection and utility installation/locating industries to increase the accuracy of buried utility/object detection. There exits a further need to enhance the accuracy of the data collected by GPR systems, and providing the GPR system operator with increased functionality to enhance the object detection process. The present invention fulfills these and other needs, and provides additional advantages over the prior art.

### SUMMARY OF THE INVENTION

The present invention is directed to a system and method for detecting underground features. According to one embodiment, a system of the present invention includes an electromagnetic detection unit, such as a ground penetrating radar unit, and a processor that receives detection data from the detection unit. A user interface device and a display are respectively coupled to the processor. The processor, in response to a user input received via the user interface device, cooperates with the display to selectively present one or both of a cross-sectional view and a plan view of the underground features detected by the detection unit.

In one configuration, the system includes a cart for transporting the electromagnetic detection unit, processor, user interface device, and display along a ground surface. In another configuration, the system is mounted on a hand-held locator frame.

According to a utility mapping mode, the plan view includes a plan view grid mapping of the underground features. The plan view indicates an orientation of the detected underground features and a spatial relationship between the detected underground features. Each survey line of the plan view grid is associated with a button presented on the display. Activation of a particular button causes the processor to display a cross-sectional view of underground features detected along the survey line associated with the particular button.

According to a utility locating mode, the cross-section view of the underground features indicates a depth of each of the detected underground features and indicates a distance to each of the detected underground features relative to a reference point. A plan view of the detected underground features in this mode indicates a distance to each of the detected underground features relative to the reference point.

Each of the detected underground features is denoted by a symbol having a particular shape and a particular color respectively corresponding to a particular detected underground feature. In one configuration, each of the detected underground features is denoted by a symbol, and the symbols are arranged within a mark bar in spatial relationship relative to each of the detected underground features. Each of the symbols within the mark bar is representative of a corresponding detection data file. Each of the detected underground features is preferably denoted by a symbol having a color conforming to a Uniform Utility Color Code.

A particularly useful feature is an electronic tape measure device which is activated by user selection of an ETM button on the display via the user interface device. The ETM device, respectively activated and deactivated via start and stop buttons, is activatable to measure a distance over a ground surface. The ETM device is activated by user selection of the ETM button preferably during times when the processor is not receiving GPR data from the detection unit.

Another feature concerns the estimation and display of signal penetration depth with respect to a given subsurface volume. An estimate of detection unit signal penetration depth can be computed using a reflected signal waveform subtraction approach. The estimated signal penetration depth is preferably presented on the display.

In accordance with another embodiment of the present invention, a method of detecting underground features involves transmitting a source electromagnetic signal into a subsurface while moving relative to a survey line, and receiving a reflected electromagnetic signal from the subsurface while moving relative to the survey line. Underground features are detected using the reflected electromagnetic signal. One or both of a cross-sectional view and a plan view of the detected underground features can be selectively displayed. A computer readable medium embodying program instructions for detecting underground features involving the above-described processes represents another embodiment of the present invention.

### BRIEF DESCRIPTION OF THE DRAWINGS

FIG. 1 is a block diagram of a system for collecting and displaying GPR data in accordance with an embodiment of the present invention;

FIG. 2 illustrates the flow of a software program and a number of functions for collecting and displaying GPR data executable from a main menu page in accordance with an embodiment of the present invention;

FIG. 3 is a flowchart that illustrates various data collection and data playback modules of the system software in accordance with an embodiment of the present invention;

FIG. 4 illustrates a main menu page which provides for selection of various software system function in accordance with an embodiment of the present invention;

FIG. 5 illustrates a data collection setup page of the software program accessible by the operator according to an embodiment of the present invention;

FIG. 6 illustrates a comments page accessible by the operator according to an embodiment of the present invention;

FIG. 7 is a graphical representation of information and functions associated with an electronic tape measure feature of the present invention;

FIG. 8 illustrates a survey grid setup page accessible by the operator according to an embodiment of the present invention;

FIG. 9 illustrates a utility mapping (grid) data collection page accessible by the operator according to an embodiment of the present invention;

FIG. 10 illustrates a utility locating (profile) data collection page accessible by the operator according to an embodiment of the present invention;

FIG. 11 illustrates a ‘run without saving’ data collection window accessible by the operator according to an embodiment of the present invention;

FIG. 12 illustrates a data viewer window accessible by the operator according to an embodiment of the present invention;

FIG. 13 illustrates a data viewer window from which a hyperbola curve matching calibration procedure can be performed by the operator according to an embodiment of the present invention;

FIG. 14 illustrates a GPR signal processing page accessible by the operator according to an embodiment of the present invention; and

FIGS. 15-17 illustrate map viewer windows for both utility locating and mapping modes according to an embodiment of the present invention.

While the invention is amenable to various modifications and alternative forms, specifics thereof have been shown by way of example in the drawings and will be described in detail hereinbelow. It is to be understood, however, that the intention is not to limit the invention to the particular embodiments described. On the contrary, the invention is intended to cover all modifications, equivalents, and alternatives falling within the scope of the invention as defined by the appended claims.

### DESCRIPTION OF VARIOUS EMBODIMENTS

In the following description of the illustrated embodiments, references are made to the accompanying drawings which form a part hereof, and in which is shown by way of illustration, various embodiments in which the invention may be practiced. It is to be understood that other embodiments may be utilized, and structural and functional changes may be made without departing from the scope of the present invention.

The present invention is directed to an improved system and method for using ground penetrating radar (GPR). In particular, the present invention is directed to software and systems that provide for the collection and presentation of data collected via GPR. A number of advantageous features are provided through implementation of the present invention, including, but not limited to, an electronic tap measure (ETM) feature, a map viewer feature, enhanced target selection feature and mark bar feature, a technique for the determination of estimated GPR depth, and on-board signal processing functions. Systems and methods of the present invention provide additional features such as grid mapping, system operation without saving data, and various calibration methodologies, including a hyperbolic curve matching calibration technique. The software also includes built in signal processing functions for enhanced data interpretation and a unique approach to displaying and mapping the interpreted data. These features provide for enhanced utility location and mapping functionality. A more detailed description of these and other features of the present invention are described in the following paragraphs and elsewhere hereinbelow.

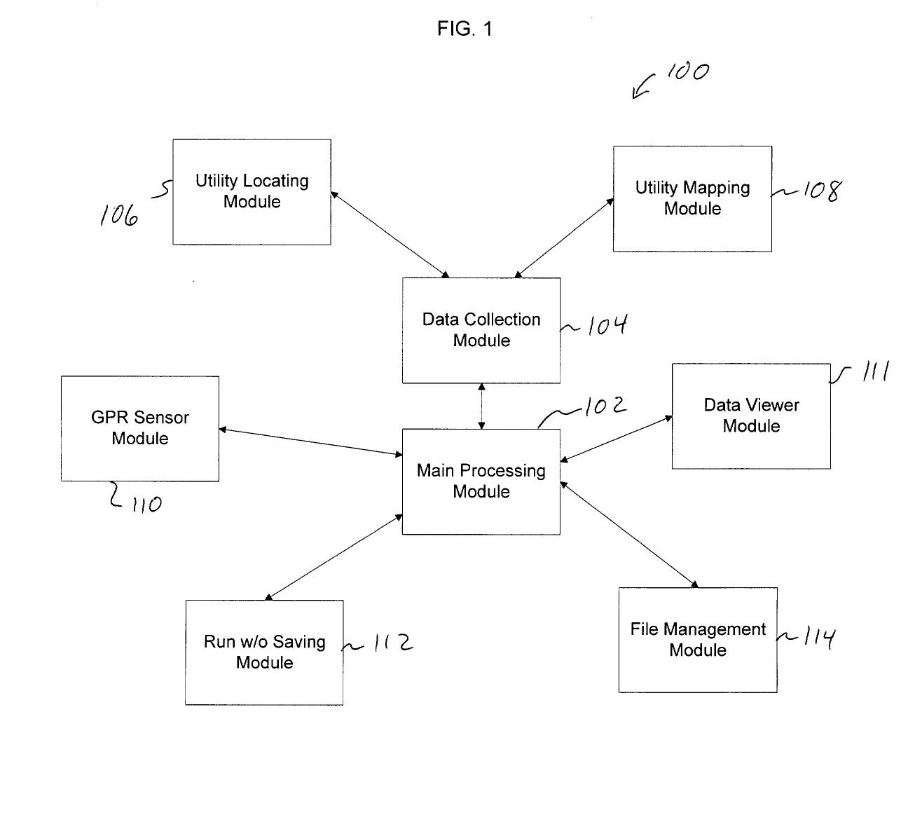

Referring now to the figures and, more particularly to FIG. 1, there is illustrated an embodiment of a system 100 for collecting and displaying GPR data in accordance with the present invention. The system 100 depicted in FIG. 1 can be implemented in software, hardware, or a combination of software and hardware. The system 100 can be implemented as a stand-alone system, integrated as part of a larger system, or implemented partially in stand-alone form and partially integral to another system. In one particular embodiment, the system 100 is implemented in a portable scanning unit, such as in a manually transportable locator-type device of a configuration known in the art. Other system configurations are contemplated, including, for example, a pull/push cart system or a system integral to, or otherwise cooperating with, an excavation machine, such as a trencher or horizontal directional drilling machine. It is understood that embodiments of the present invention find applicability in a wide variety of system and machine configurations and are not limited to those described specifically herein.

The system 100 shown in FIG. 1 includes a number of modules which form a GPR data processing system according to one embodiment of the present invention. According to this embodiment, the system 100 includes a main processing module 102 which is coupled to a data collection module 104. The main processing module 102, as well as other modules shown in FIG. 1, can be implemented as software, hardware, or a combination of hardware and software. The main processing module 102 is communicatively coupled to a GPR sensor module 110. The GPR sensor module 110 can be representative of a software, hardware, or software/hardware module that collects and/or pre-processes GPR data obtained with use of a GPR sensor.

It is understood that the GPR sensor and related data as discussed herein is intended to represent any type of radar-like scanning sensor and data, and is not limited to sensing devices and data associated only with those signal types and frequencies applicable to ground penetrating radar as this technology is presently understood. The systems and techniques described herein are applicable to a variety of ground imaging technologies which utilize electromagnetic signals to probe the earth. It is believed that various systems and methodologies of the present invention are also applicable in the context of acoustic or seismic probing techniques.

The GPR sensor module 110 is shown coupled to the main processing module 102, but can alternatively be coupled to the data collection module 104 or other module(s) of system 100. As shown, the GPR sensor module 110 collects or otherwise processes collected GPR sensor data and transmits raw GPR sensor data to the main processing module 102. The GPR sensor module 110 can also be implemented to pre-process the GPR sensor data, and, if desired, can communicate both raw and pre-processed GPR sensor data to the main processing module 102.

The main processing module 102 cooperates with the data collection module 104 to collect and process GPR sensor data and other data when available (e.g., ground surface distance measurements, topography and other surveying information, absolute geographical positioning data, such as that acquired through use of a GPS device, geophysical data acquired through use of one or more geophysical sensors, such as electromagnetic, seismic, or mechanical sensors, dielectric constant data, etc.).

The data collection module 104 is shown coupled to, or otherwise incorporates, a utility locating module 106 which provides for the collection of GPR sensor data while operating in a utility locating mode. The data collection module 104 is also shown coupled to, or otherwise incorporates, a utility mapping module 108 which provides for the collection of GPR sensor data while operating in a utility mapping mode. These data collection modes and associated modes of displaying collected GPR sensor data will be described in greater detail hereinbelow.

A data viewer module 111 is shown coupled to the main processing module 102. The data viewer module 111 provides for the selective displaying of GPR sensor data and other related data in a variety of forms, examples of which will be discussed in detail below. The data viewer module 111 is coupled to, or otherwise incorporates, a display device, such as a CRT, LCD, or plasma display, for example. The display device may be configured as a touch screen responsive to a tactile force via a finger, stylus, or other implement. The display device is typically situated proximate the GPR sensor module 110. In certain configurations, the display device may be situated remotely from the GPR sensor module 110, such as near or on an excavation machine. In yet another configuration, a first display device may be situated proximate the GPR sensor module 110 and a second display device may be situated remotely from the GPR sensor module 110.

A file management module 114 and a run without saving module 112 are also shown respectively coupled to the main processing module 102. The run without saving module 112 provides for operating the system 100 in a variety of modes without saving acquired GPR sensor data to a storage medium, such as a hard disk of a direct access storage device. The file management module 114 provides for the management of GPR data files stored in the system, such as the selective deletion of unwanted GPR data files, for example. These modules and other features of the present invention will now be described in greater detail.

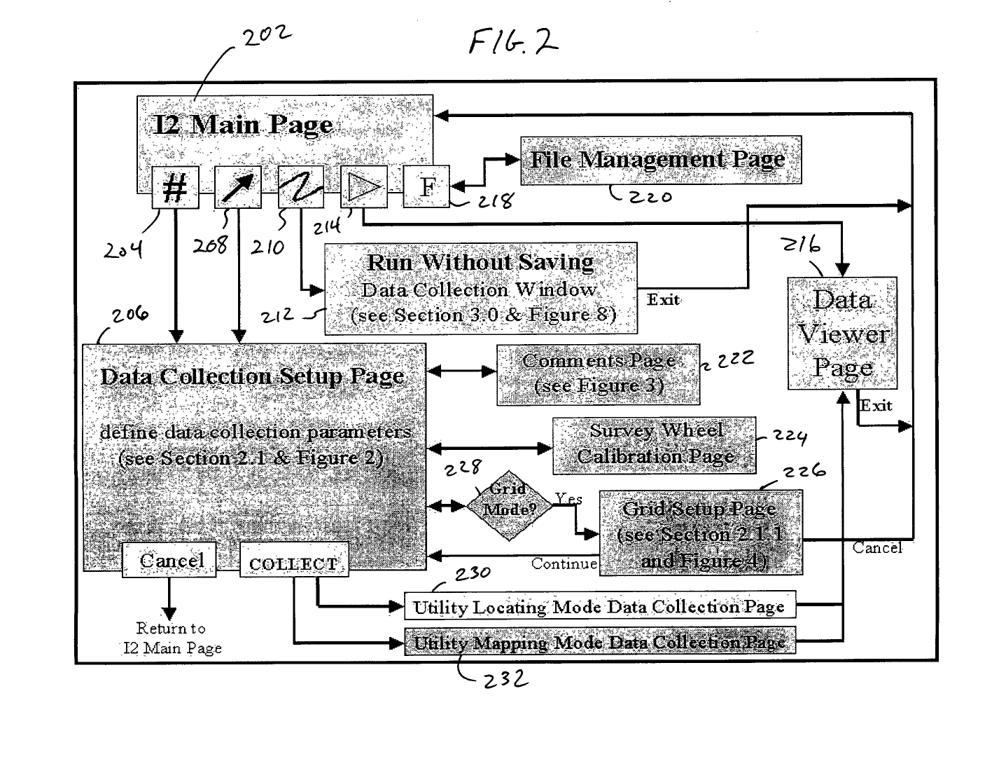

FIG. 2 is a depiction of a GPR data processing program layout according to an embodiment of the present invention. In particular, FIG. 2 illustrates the flow of a software program and a number of functions executable from a main page 202. The program flow depicted in FIG. 2 focuses primarily on the data collection setup sequence in relation to the rest of the program. The run without saving and file management functions 212, 220 are also shown. A number of buttons allow a user to activate the functions available through the main page 202. A utility mapping button 204 and a utility locating button 208 respectively provides access to a data collection setup page 206.

Activation of the utility mapping button 204 invokes a utility mapping mode data collection page 232. Activation of the utility locating button 208 invokes a utility locating mode data collection page 230. Each of these pages 230, 232 provide access to the data viewer page 216. The data viewer page 216 can also be accessed directly from the main page 202 by activation of the data viewer button 214. The run without saving page 212 can be accessed via activation of button 210, and the file management page 220 can be accessed via activation of button 218.

A number of functions are activatable from the data collection setup page 206. A comments page 222 can be accessed via the data collection setup page 206. A survey wheel calibration page 224 can also be accessed via the data collection setup page 206. As is also shown, if a grid mode 228 is selected, a grid setup page 226 is accessed via the data collection setup page 206. These pages will be described in greater detail hereinbelow.

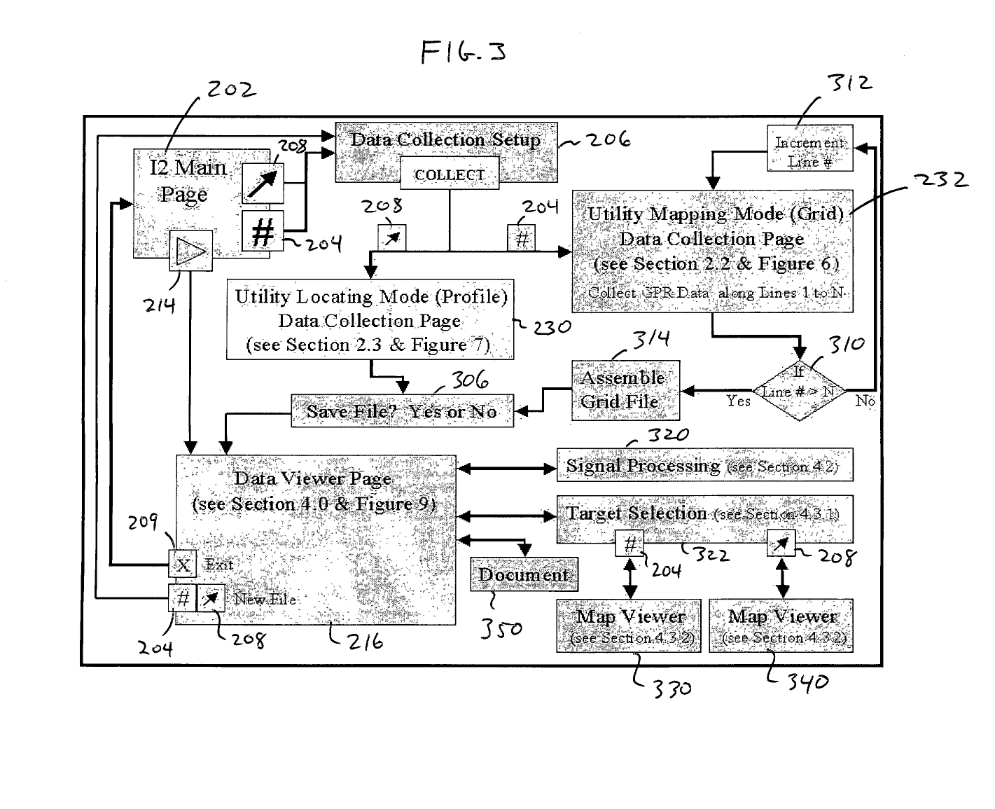

FIG. 3 is a flowchart that illustrates various data collection and data playback modules of the system software. The process of acquiring data in either the utility locating (profile) mode or utility mapping (grid) mode is depicted, as well as particular features and functionality of the data viewer page or window 216. As was described above, the data collection setup page 206 can be accessed via activation of the utility mapping and locating buttons 204, 208, respectively. Activation of the utility locating mode data collection page 230 via utility locating button 208 provides for the acquisition of individual GPR data profiles. The GPR data profiles are used primarily for locating buried pipes, obstructions, targets, or geologic structures. After generation of a GPR data profile, the user has the option to save or discard 306 the GPR data profile.

Activation of the utility mapping mode data collection page 232 via the utility mapping button 204 provides for the acquisition of a grid of GPR data. The grid of GPR data is used primarily for creating target plan maps. According to one data acquisition methodology, GPR data is collected along a number of grid lines, L₁ through L_{N}. GPR data is collected along each of the grid lines, L₁ through L_{N}, until N number of grid lines have been scanned, as indicated in blocks 232, 310, and 312. After collecting GPR data for each of N number of grid lines, a grid file is assembled 314. The assembled grid file can be saved or discarded 306 by the user.

The data viewer page 216 can be directly accessed and activated via the data viewer button 214 from the main page 202. The data viewer page 216 can also be activated via each of the utility locating and mapping mode data collection pages 230, 232. As will be discussed in greater detail, various GPR signal processing functions 320 can be selectively activated by the user via the data viewer page 216. A number of target selection functions 322 can also be activated via the data viewer page 216. Map viewers 330, 340 can be invoked via a target selection page 322 associated with utility mapping and locating functions, respectively. Various types of documents 350 can be generated.

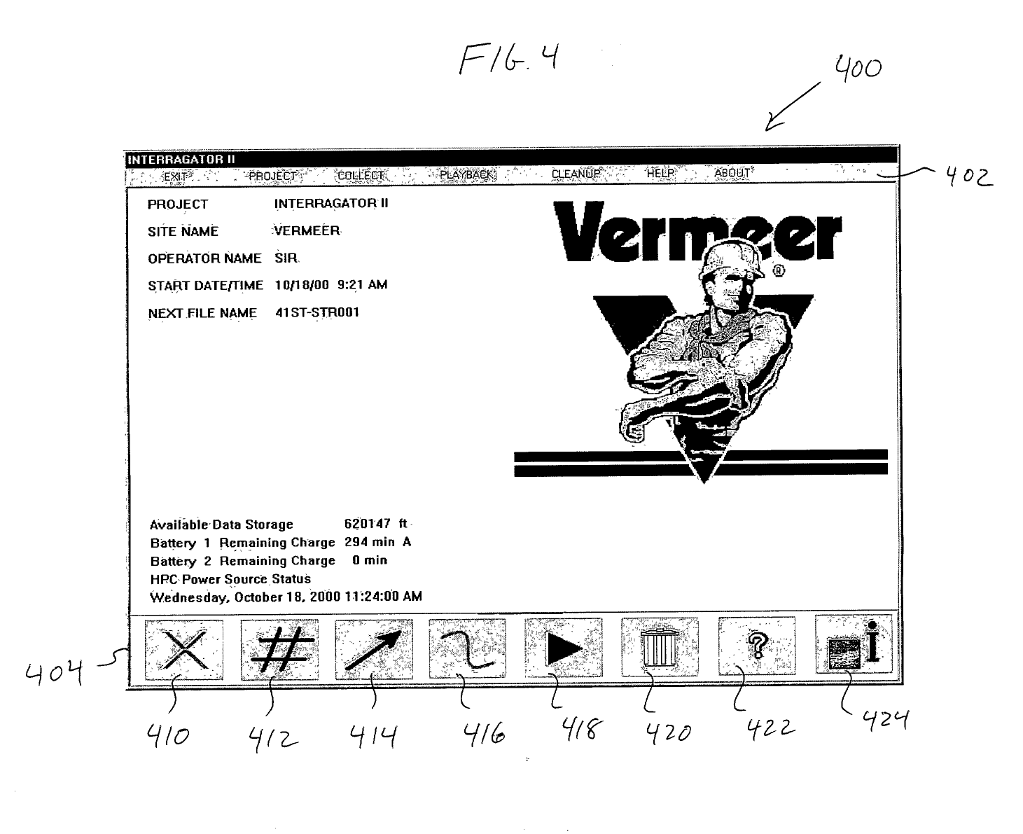

Turning now to FIG. 4, there is illustrated a main menu page 400 which provides for selection of various software system function in accordance with an embodiment of the present invention. Project information, which includes site name, operator name, start date/time, and file name, is presented on the main menu page 400. Other information, such as available data storage space, primary and backup battery charge information, power source status, and date and time information, is also presented on the main menu page 400. A main task bar 402 provides user activation of a number of system functions (e.g., exit, project functions, data collection functions, playback/display functions, file cleanup functions, and help and information functions).

A GPR system task bar 404, referred to herein as Task Bar 1, provides for activation of a number of GPR related system functions. The exit button 410 terminates the GPR program and returns the operator to the operating system's main display (e.g., WINDOWS NT). The GPR antenna is also turned off upon activation of the exit button 410.

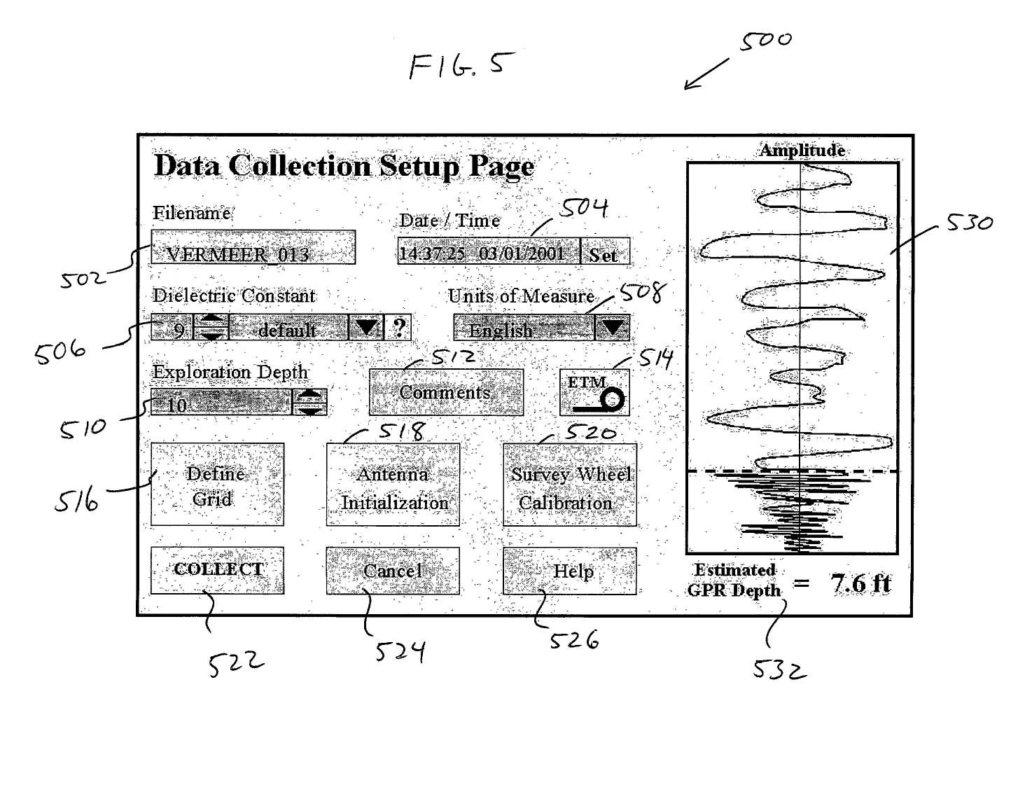

In preparing for data collection, regardless of whether the utility mapping button 204 or utility locating button 208 has been selected in Task Bar 1, the operator is presented with the data collection setup page 500 shown in FIG. 5. For either of the functions, the layout of the data collection setup page 500 is essentially the same. One difference is that during the utility locating (profile) mode, the define grid button 516 is inactive.

A utility mapping button 412, shown in FIG. 4, can be selected to initiate the acquisition of a grid of GPR data with the primary intent of creating target plan maps. Selection of the utility mapping button 412 invokes the data collection setup page 500 shown in FIG. 5. The following parameters and buttons are made available on the data collection setup page 500:

1. Filename via window 502

2. Date/Time via window 504

3. Dielectric Constant via window 506

4. Units of Measure via window 508

5. Exploration Depth via window 510

6. Comments button 512

7. ETM button 514

8. Define Grid button 516

9. Antenna Initialization button 518

10. Survey Wheel Calibration button 520

11. Collect button 522

12. Cancel button 524

13. Help button 526

The filename window 502 permits the operator to enter up to a twelve (12) character file name, to which the program will add a four (4) digit numeric suffix. The suffix will begin with “_{—}001” or be incremented by one over the previous filename having the same 12 character prefix. An example filename is ‘MAPLE_STREET_{—}007’. At system start up, the default file name prefix will always be the same name, such as ‘VERMEER’. Returning to this page during system operation, the last saved file name will be displayed with the numeric suffix incremented by 1. The date/time window 504 permits the operator to establish the current date and time of the GPR survey.

The dielectric constant parameter can be input or selected via window 506. The dielectric constant parameter is represented with a numeric value and text descriptor. The operator can select a dielectric constant value between 1 (air) and 81 (water). The default value is 9, which is a useful value for most applications. From the default value, the value may be increased or decreased using the increment/decrement buttons. A drop down menu is also available for selection of the dielectric constant value. Some common soil, rock, and other material types are listed with an associated dielectric value. Selection of a material type will populate the numeric box with the selected value and the text box with the selected material type. Tapping the ‘?’ button displays a dialog box showing a more extensive list of dielectric constant values for common soil, rock, and other material types. This table of values is to be used as a guide.

Depth and distance measurements are presented in English or Metric units, as selected using window 508. The default selection is English units. Whenever the units of measure parameter changes, a survey wheel calibration should be performed.

The exploration depth can be selected via window 510. The operator may enter an exploration depth value directly or use the increment/decrement buttons to select a value of 1 to 25 ft in 0.5 ft increments or 0.25 m to 8.00 m in 0.25 m increments. The default exploration depth value is 10.0 ft or 3.00 m, depending on the units of measure parameter. At the bottom of the signal waveform window 530, the estimated depth of exploration 532 is computed from the data signal. This value should be used as a guide when setting the depth of exploration via window 510.

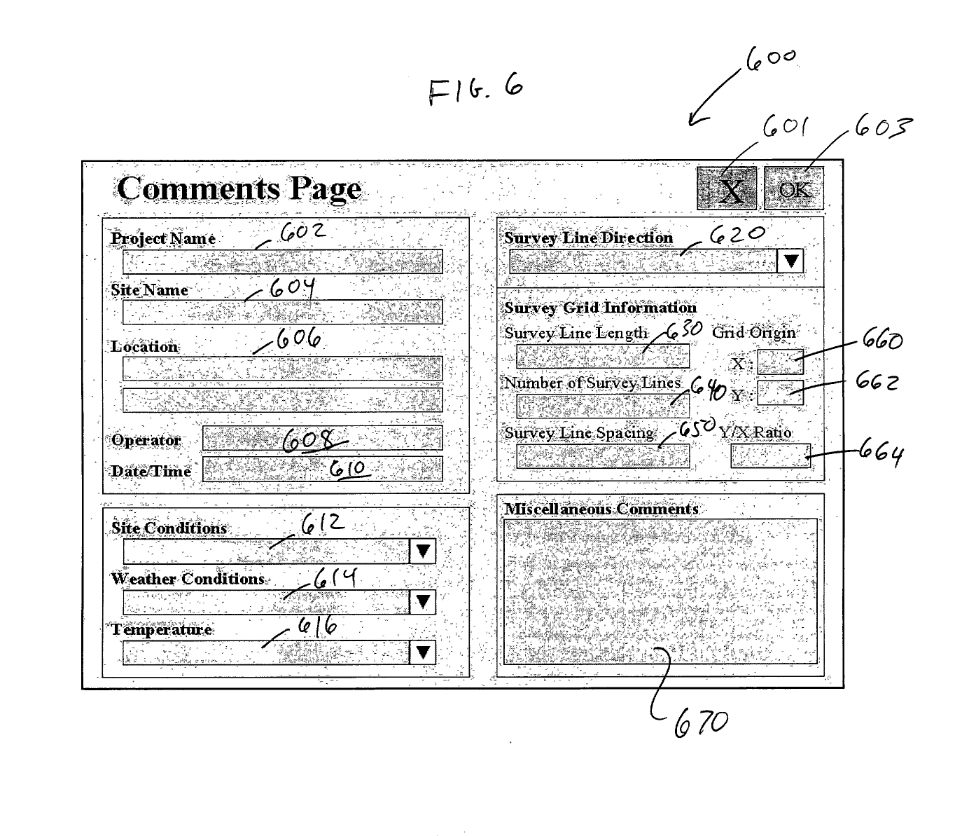

Selection of the comments button 512 takes the operator to the comments page 600, shown in FIG. 6, where the following information can be entered about the GPR survey:

1. Project Name via window 602

2. Site Name via window 604

3. Location (Street, City, State) via window 606

4. Operator Name via window 608

5. Date/Time (populated from Date/Time parameter) via window 610

6. Surface/Site/Soil Conditions (select from list) via window 612

7. Weather Conditions (select from list) via window 614

8. Temperature (select from list) via window 616

9. Survey Line Direction via window 620

10. Grid Parameters (from the Define Grid menu) via windows 630, 640, 650, 660, 662, and 664

11. Miscellaneous Comments via window 670

Comments should be entered (although not necessary) to assist the operator with project bookkeeping following the job. After any comments have been entered, the operator can select the ‘OK’ button 603 to return to the data collection setup page 500 of FIG. 5. The cancel (X) button 601 returns the operator to the data collection setup page 500 without saving any of the comments window changes. The comments page 600 may be accessed as many times as necessary.

The ETM button 514 of the data collection setup page 500 shown in FIG. 5 accesses the electronic tape measure. The electronic tape measure provides for measuring of distances with a survey wheel encoder without having to exit the software or physically lay out a tape measure. In particular, the electronic tape measure feature provides for measuring of surface distances between two points when the system is not collecting GPR data. Many systems have distance counters, but the counters are only active when the system is collecting data. The ETM feature is unique in that it allows the operator to layout a survey grid, measure survey line distances, or distances to reference points while the system is not in use.

During GPR surveying and mapping, an operator often has the need to measure distances on the ground surface. These measurements are typically to layout survey lines, locate reference points, note the location of surface features, or locate detected targets. A nylon or metal tape is usually required for these purposes. Use of the electronic tape measure feature of the present invention obviates the need for these conventional distance measuring approaches. The electronic tape measure makes use of an onboard survey wheel encoder to measure distances. Most windows of the software have an ETM button 514 so that the operator may access this mode at any time to measure a distance. In the data collection modes, the ETM button 514 will not be active during GPR data collection because the survey wheel is already actively recording data.

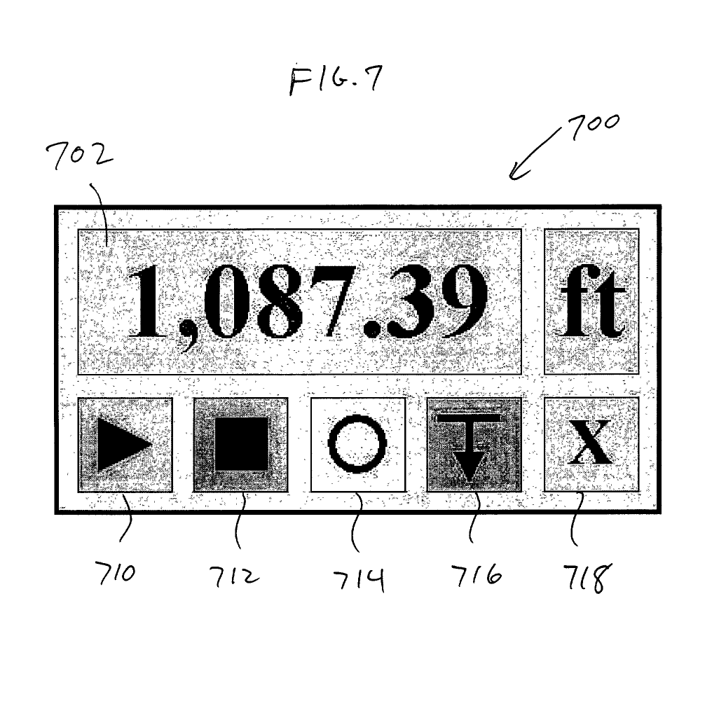

Selecting the ETM button 514 invokes a dialog box 700, shown in FIG. 7, to the display illustrating a distance counter window 702 and five (5) buttons: a start button 710, a stop button 712, a reset button 714, a calibrate button 716, and an exit button 718.

The start button 710 initiates measuring of a distance. The stop button 712 is activated to end the distance measurement session. The reset button 714 resets the distance counter back to zero (0). The calibrate button 716 invokes the survey wheel calibration procedure. Activation of the exit button 718 terminates the electronic tape measure mode and returns the operator to the previous display window. At this point, the operator may continue normal use of the GPR system. The electronic tape measure may be activated whenever the survey wheel encoder is not already in use and may be accessed as many times as necessary. The distance data, however, is generally not saved to a file, but may be saved if needed or desired.

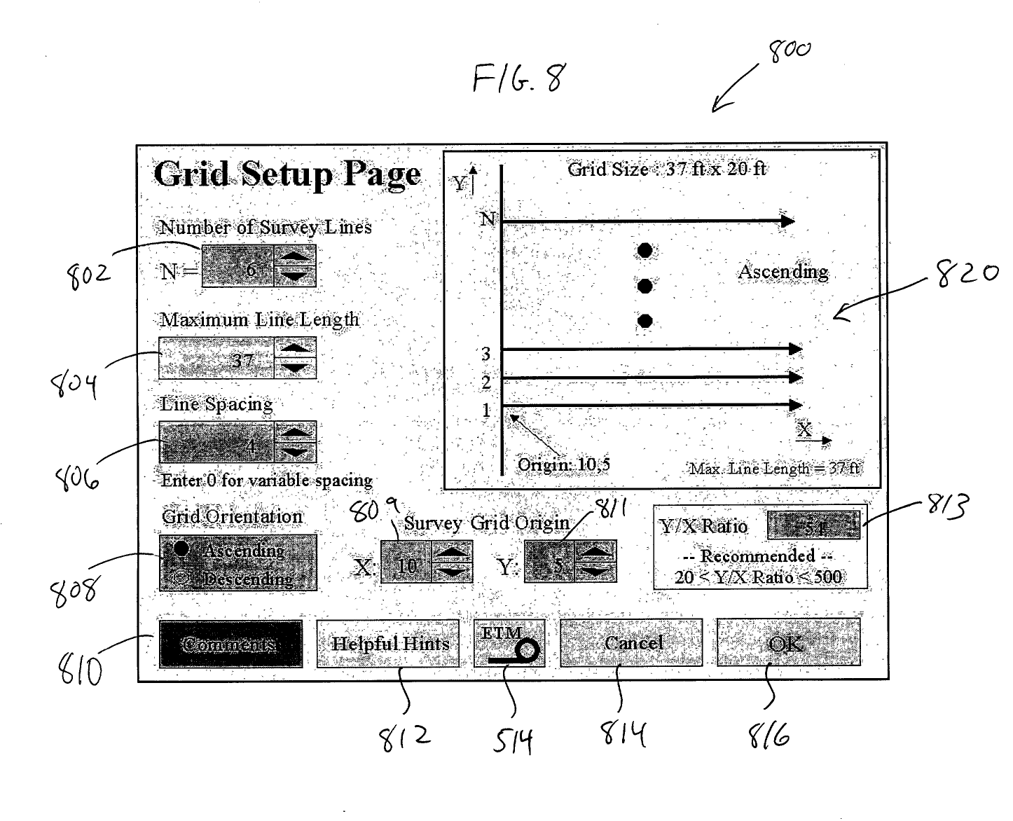

As is further shown in FIG. 5, a define grid button 516 invokes a grid setup page 800, which is shown in FIG. 8. The grid setup page 800 permits the operator to enter parameters necessary to survey several adjacent survey lines at one time. This button 516 is inactive during the utility locating (profile) mode.

When the utility mapping button 412 is selected on the main menu page 400, as is shown in FIG. 4, the operator is required to define the parameters of the survey grid. These parameters are accessed via the define grid button 516 on the data collection setup page 500, as is shown in FIG. 5. This button 516 is only active in the utility mapping mode. Selection of the define grid button 516 takes the operator to the grid setup page 800, as is shown in FIG. 8.

The grid setup page 800 includes a number of survey lines window 802 with which the operator enters the number of survey lines in the grid. The default number is 5. The number of lines is increased or decreased using the increment/ decrement buttons. A maximum line length window 804 permits the operator to input the maximum line length by entering the value directly or using the toggles to increase or decrease the value presented. The value is defined to the nearest 1.0 ft or 0.5 m. The default length value is 20 ft or 6.0 m.

A line spacing window 806 permits entering of the spacing between adjacent survey lines. The default value is 1 ft or 0.5 m. Values can be increased or decreased in 1 ft or 0.5 m intervals using the increment/decrement buttons. The operator may also enter a value of zero (0) to denote a variable line spacing, which is useful when surveying the length of a street.

Survey grid orientation can be selected as being either ascending or descending via window 808. With the operator standing at the origin of the grid (Survey Line 1) and facing the survey direction, an ascending grid orientation is defined to have survey line numbers that increase towards the left. A descending grid orientation is defined to have survey line numbers that increase to the right. The schematic of the grid 820 indicates an ascending grid orientation.

The origin of the survey grid can be defined using windows 809 and 811 for documentation purposes. The default grid origin is defined to be X=0 and Y=0. These values may be increased or decreased using the increment/decrement buttons. The values may also be input directly. The Y/X ratio value, shown in window 813, is provided as a guide that is useful for producing realistic, easy to visualize plan maps of the area surveyed. The Y value is defined as the distance between the first and last survey lines. The X value is the maximum line length. The Y/X ratio is determined by dividing the value Y by the value X and multiplying the result by 100. It is recommended that the Y/X ratio be a value between 20 and 500 for good plan maps.

The comments button 810 allows the operator to enter additional comments concerning the grid layout. These comments may include variable line spacing, survey obstacles, and grid locations, for example. A helpful hints button 812 is intended to provide help information for the grid setup parameters, as well as information concerning grid layout and surveying techniques.

The ETM button 514 accesses the electronic tape measure, which was previously discussed. A cancel button 814 permits the operator to exit from the grid setup page 800 and returns to the data collection setup page 500. After all of the grid setup parameters have been entered, the operator selects the OK button 816 to return to the data collection setup page 500 shown in FIG. 5.

Using the grid input parameters specified above, a schematic 820 of the grid layout is generated in the upper right hand corner of the grid setup page 800 to help the operator visualize the defined survey grid. The schematic 820 illustrates the orientation of the grid and lists the grid size and survey line length. The origin of the grid is also noted. It is noted that all grid lines are to be surveyed in the same direction and in numerical order, beginning with survey line 1.

Returning to FIG. 5, antenna initialization can be initiated by activation of the antenna initialization button 518. This button 518 is used to reinitialize the GPR system antenna at the current system location. During each action, the system redefines the signal gain values and filter settings. This button 518 can be selected as often as necessary.

A survey wheel calibration button 520 allows the operator to calibrate the survey wheel encoder of the system. One unique feature is the ability to select an offset distance. The offset distance value allows the operator to adjust the target location point for the GPR system. Parameter selections include: 1) center of antenna (default); 2) cart axle; 3) back of cart; or 4) target marking system (if available). It is noted that the value ‘Number of Tics per Unit’ should reflect the distance traveled. For example, for the metric or English unit systems, this value should be proportionally related to the distance traveled.

Selection of the collect button 522 from the data collection setup page 500 shown in FIG. 5 initiates the data collection process for both the utility mapping (grid) mode or utility locating (profile) mode. It is noted that in the utility mapping (grid) mode, an error message will appear if a grid has not been defined.

A cancel button 524 allows the operator to discontinue the data collection setup process and return the operator to the main menu page 400 shown in FIG. 4. A help button 526 provides helpful information regarding the data collection setup page 500. GPR survey techniques and planning tips are also included.

The data collection setup page 500 also includes a GPR signal waveform window 530 showing a received GPR signal. This window 530 provides the operator with information concerning the signal quality and depth to which to expect good signal penetration. The waveform window 530 graphically displays the received signal waveform at the receiver antenna. From the waveform captured in the waveform window 530, the signal quality and estimated depth of exploration are determined. The estimated GPR depth 532, displayed at the bottom of the window 530, can be determined by comparing the received signal waveform at two different times, typically during initialization. Subtracting waveforms, where the data exceeds a specified interval either side of zero, gives some indication of the noise floor and, hence, the depth of signal penetration.

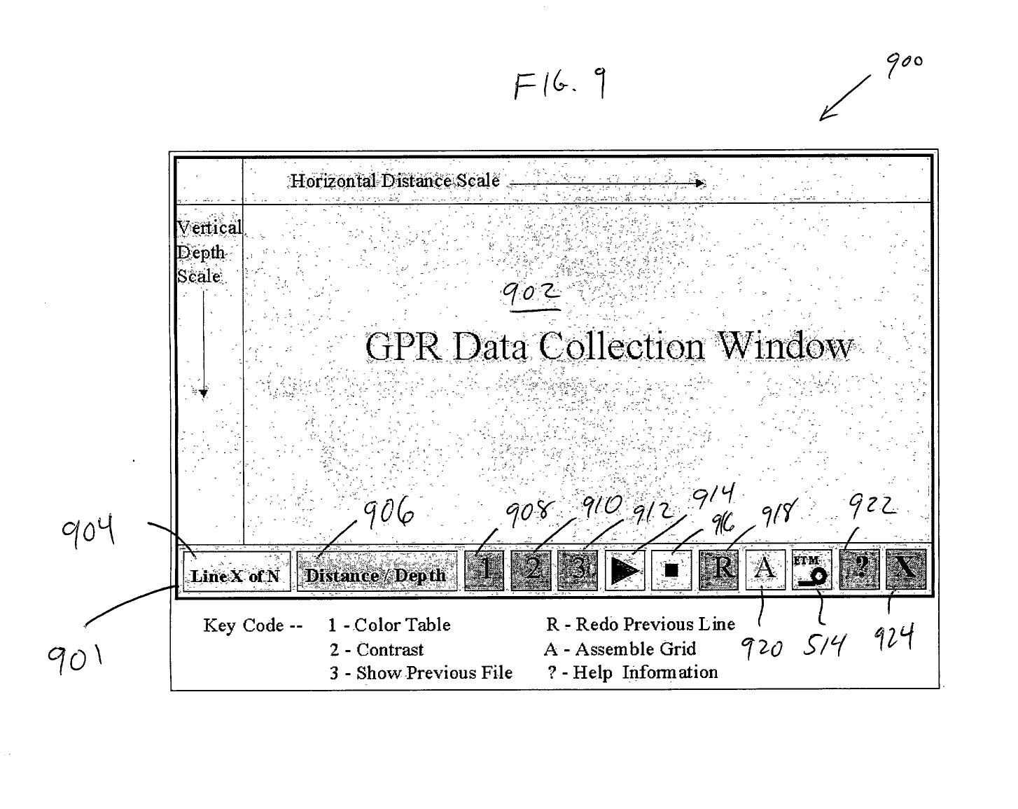

As was discussed briefly above, from the data collection setup page 500, the operator can select the collect button 522 to begin acquiring GPR data. GPR data can be collected in a utility locating mode or in a utility mapping mode. In accordance with an embodiment in which GPR data is collected in a utility mapping mode, the utility mapping data collection window 900 shown in FIG. 9 is presented to the operator. The list of parameters or functions presented in the task bar (Task Bar 2) 901 are as follows:

1. Current Line Number indicator 904

2. Distance and Depth indicator 906

3. Color Table button 908

4. Color Contrast button 910

5. Show Previous File button 912

6. Start button 914

7. Stop button 916

8. Redo Survey button 918

9. Assemble Grid File button 920

10. ETM button 514

11. Help button 922

12. Exit button 924

Details concerning the parameters and button functions of the task bar (Task Bar 2) 901 along the bottom of the utility mapping data collection window 900 are described as follows. The line number indicator 904 allows the operator to determine which survey line is being collected and how many surveys yet remain. An exemplary message presented by the indicator 904 is ‘Line X of N,’ where ‘X’ is the current survey line and ‘N’ is the total number of survey lines. The ‘X’ value is incremented when the stop button 916 is selected at the end of a survey line.

The distance/depth indicator 906 serves a two-fold function during data acquisition. First, the indicator 906 displays the distance and depth coordinates of a stylus pen. This is active while the backup cursor is displayed or the survey line has been completed. The second function is an active distance counter displayed during data collection. This counter indicates the distance traveled in real time so the operator has an idea when the survey line is about to end.

A color table button 908 allows the operator to select some 6 to 8 color tables for data presentation. As some of the color tables can have four associated color transforms to provide data contrasts, a color contrast button 910 can be activated to select desired levels of color contrasts. A show previous file button 912 may be selected to display the previously collected survey in the grid while collecting the current data file. This button 912 must be selected prior to starting data collection along a survey line. The second data file is to be used as a utility location guide.

A start button 914 can be activated to initiate data collection along a survey line. The current survey line number is presented in the line number indicator box 904. A stop button 916 permits the operator to terminate data collection along a survey line prior to the maximum line length value being reached. Once selected, the program asks the operator whether or not to save the data file.

Selection of the redo previous survey line button 918 permits reacquiring of the previous or just collected survey line. This button 918 is typically activated when the operator is not satisfied with the collected data, the wrong line was surveyed, or the operator strayed off the survey line. When all the survey lines of the grid have been collected and saved, the operator can select the assemble grid file button 920 to assemble the survey lines into a single file. The ETM and help buttons 514 and 922 function in manners previously described. Selecting the exit button 924 terminates the data collection process and returns the operator to the data collection setup page 500 of FIG. 5.

The following is a brief description of a utility mapping data collection process according to an embodiment of the present invention. From the data collection setup page 500, the operator can select the collect button 522 to proceed to the utility mapping (grid) data collection page 900 shown in FIG. 9. If an error message occurs, it is likely the operator has not defined the survey line grid. When the grid is defined, the collect button 522 will cause the utility mapping (grid) data collection window 900 to be displayed. The utility mapping (grid) data collection page 900 has the horizontal distance scale displayed at the top of the window and the depth scale along the left side. The backup cursor feature is available during data collection.

The operator should next move the GPR sensor cart to the beginning of survey line 1. The line counter box 904 will read ‘Line 1 of N,’ where N is the total number of survey lines. When ready to begin collecting data, the operator presses the start button 914 and begins moving the GPR sensor cart along the survey line. GPR data will begin to appear on the display 902 and the distance/depth box 906 will indicate the distance along the survey line. The operator may use the backup cursor at any time.

When the GPR sensor cart has moved the maximum line length, data collection will stop and the GPR data file will be saved automatically. The operator then moves the GPR sensor cart to the start of survey line 2 as indicated in the line counter box 904. Once again, the operator presses the start button 914 to begin collecting GPR data along survey line 2. If the operator is unable to complete the entire survey line because of obstructions (parked cars, hydrants, curbs), the stop button 916 may be selected to terminate data collection and save the GPR data file.

The operator may also want to resurvey the last or previous grid line. In this case, the operator selects the redo previous survey line button 918, which deletes the previous data file, and moves the GPR sensor cart to the beginning of the survey line just completed. It is noted that when the system is not collecting GPR data, the ETM button 514 is active in case the operator needs to measure the distance between two objects or points.

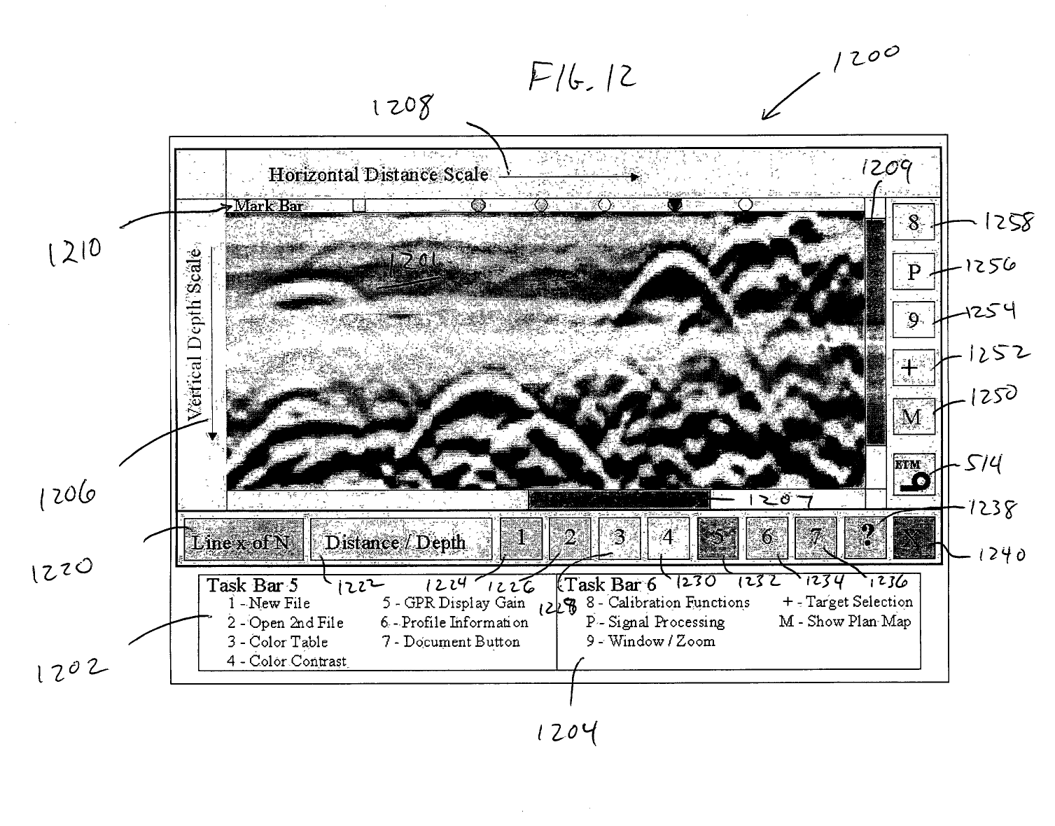

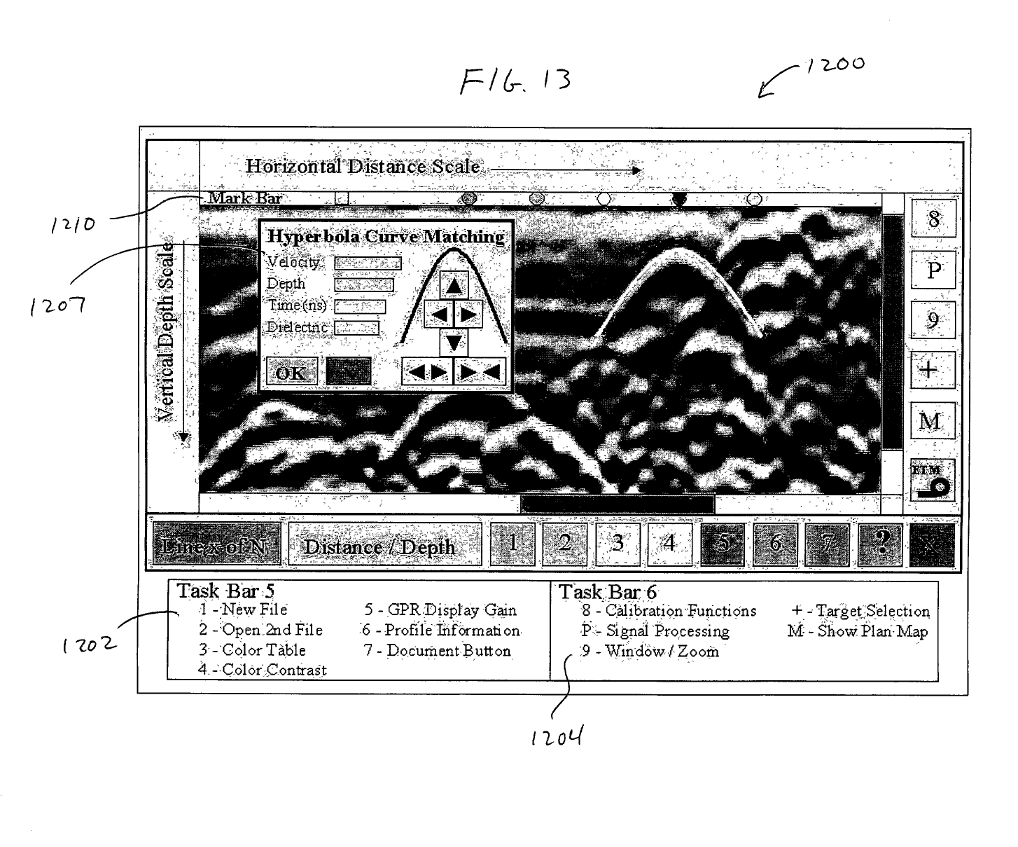

When all the grid lines have been surveyed and saved, the operator can select the assemble grid button 920. This action assembles each survey grid file into a single file for later processing and display. Once the files are assembled, the operator is asked whether or not to save the data. Regardless of whether the data is saved or not, the assembled GPR data file will now be presented in the data viewer window (see, e.g., FIGS. 12 and 13), where additional processing and mapping functions can be performed. It is noted that a backup cursor feature is also active during data collection for impromptu marking of detected targets. Following data collection and assembly of the grid file, the software transports the operator to the data viewer.

To collect additional data along another grid, the operator can select the new file button in the data viewer window (see FIGS. 12 and 13), which will bring up the data collection setup page 500 again. The operator can make changes as necessary to define the new grid and select the collect button 522 to bring up the utility mapping (grid) data collection window 900. The operator moves the system to the beginning of survey line 1 of the new grid and once again presses the start button 914 to begin collecting GPR survey data.

The utility mapping (grid) function is designed to acquire survey grid data as efficiently as possible, and the operator is expected to analyze the data later, whether in the data viewer window following grid data collection or back at the office. This is unlike the utility locating window, discussed in the following paragraphs, where the operator is able to calibrate the data and select targets while surveying.

The utility locating button 414 can be selected from the main menu page 400 shown in FIG. 4 to initiate acquisition of individual GPR data profiles. Acquired GPR data profiles are typically used for purposes of locating buried pipes, targets, or geologic structures, for example. Selection of this button 414 calls up the data collection setup page 500 of FIG. 5, where the list of parameters and function buttons and the signal waveform window previously described for the utility mapping function are found. The difference on the data collection setup page for the utility locating function in comparison to the utility mapping function is that the define grid button 516 is inactive. Once the data collection parameters are entered, the operator can selects the collect button 522 of FIG. 500 to begin acquiring GPR data.

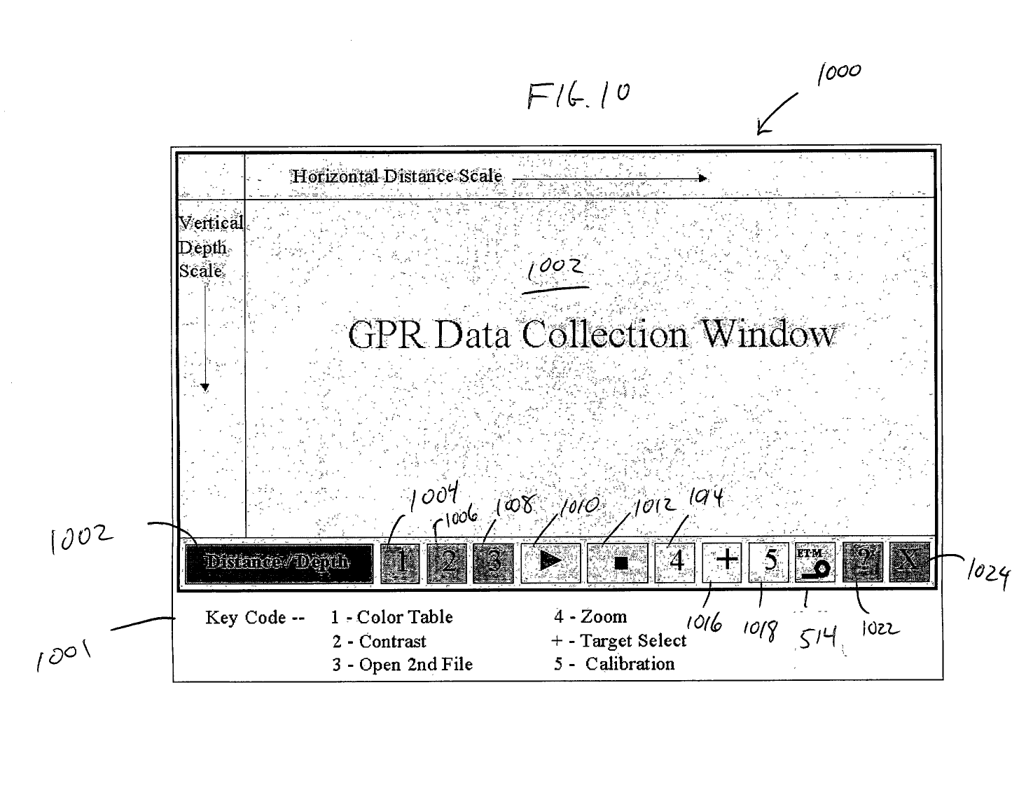

Referring now to the utility locating data collection page 1000 shown in FIG. 10, the list of parameters and functions presented in the task bar (Task Bar 3) 1001 are as follows:

1. Distance/Depth indicator 1002

2. Color Table button 1004

3. Color Contrast button 1006

4. Open 2^{nd} File or Show Previous File button 1008

5. Start button 1010

6. Stop button 1012

7. Zoom button 1014

8. Target Select button 1016

9. Calibration button 1018

10. ETM button 514

11. Help button 1022

12. Exit button 1024

The distance/depth indicator 1002, color table button 1004, and color contrast button 1006 function in the same manner discussed above with reference to indicators/buttons 906, 908, and 910 in FIG. 9. The start, stop, ETM, and help buttons 1010, 1012, 514, 1022 function in the same manner discussed above with reference to buttons 914, 916, 514, and 922 in FIG. 9.

The Open 2^{nd} File button 1008 allows the operator to display a previously collected GPR survey data file. This survey data file is displayed in the lower half of the window 1002 while GPR data is acquired in the upper half of the window 1002. This button 1008 must be selected prior to starting data collection along a survey line. The second data file is to be used as a utility location guide and confirmation guide only.

A stylus can be used with the zoom button 1014 to select a window of GPR data to enlarge for better data interpretation. This function may be used twice to effectively enlarge an area by a factor of 4 times the original size. This feature is only active while the backup cursor is displayed.

The target select button 1016 is used to determine the locations and depths of targets detected during surveying. The target select feature allows the operator to use a mouse arrow or stylus to determine the surface location and subsurface depth to the top of a buried target. The position and depth of a selected target are displayed in the distance/depth box 1002 and written to an ASCII file unique to this data file. This button 1016 is only active when the backup cursor feature is displayed. The target select button 1016 may be used as many times as desired along a survey line.

The calibrate function, initiated upon activation of the calibration button 1018, allows the operator to perform either a hyperbolic curve match or depth calibration on a detected target. Data calibration is described in greater detail hereinbelow. This function is only active when the backup cursor is displayed. Selection of the exit button 1024 terminates the data collection process and returns the operator to the data collection setup page 500 of FIG. 5. The operator is asked if the data is to be saved.

The following is a brief description of a utility locating data collection process according to an embodiment of the present invention. From the data collection setup page 500 of FIG. 5, the operator can select the collect button 522 to proceed to the utility locating (profile) data collection page 1000 shown in FIG. 10. The operator should move the GPR sensor cart to the beginning of the survey line. If a second data file is to be displayed for comparison purposes, this file can be selected at this time. The ETM button 514 is also active at this time.

When ready to begin collecting data, the operator presses the start button 1010 and begins moving the GPR sensor cart along the survey line. GPR data will begin to appear on the display 1002 and the distance/depth box 1002 will indicate the distance along the survey line. The operator may use the backup cursor at any time. While the backup cursor is displayed, the operator may calibrate the system, zoom in on a section of data, or select and label a detected target. When the GPR sensor cart has reached the end of the survey line, the operator can select the stop button 1012 to end the data collection process. A ‘Save Data?’ dialog box will appear on the display.

Regardless of whether the data is saved or not, the GPR data will now be presented in the data viewer window (see, e.g., FIGS. 12 and 13) where additional functions can be performed and applied to the data. To resume collecting data along another survey line, the operator can select the new file button in the data viewer window which will bring up the data collection setup page 500 of FIG. 5 again. The operator can make changes, if any, as necessary and select the collect button 522 to call up the utility locating (profile) data collection window 1000 of FIG. 10. The operator moves the GPR sensor system to the beginning of another line and once again presses the start button 1010 to begin collecting data. It is noted that the backup cursor feature is active during data collection for marking detected targets. Following data collection, the software transports the operator to the data viewer (see FIGS. 12 and 13).

Returning to the main menu page 400 in FIG. 4, the run without saving button 416 can be activated to rapidly acquire GPR data at a project site when searching for buried utilities and obstructions. In the run without saving mode, the system operates only with default parameter settings and data is not saved to the system's hard disk. The data collection page 1100 in this mode offers a few basic buttons and functions, including:

1. Distance/Depth indicator 1102

2. Clear Display button 1104

3. Color Table button 1106

4. Color Contrast button 1108

5. Start button 1110

6. Stop button 1112

7. Zoom button 1114

8. Calibration button 1116

9. ETM button 514

10. Help Information button 1118

11. Exit button 1120

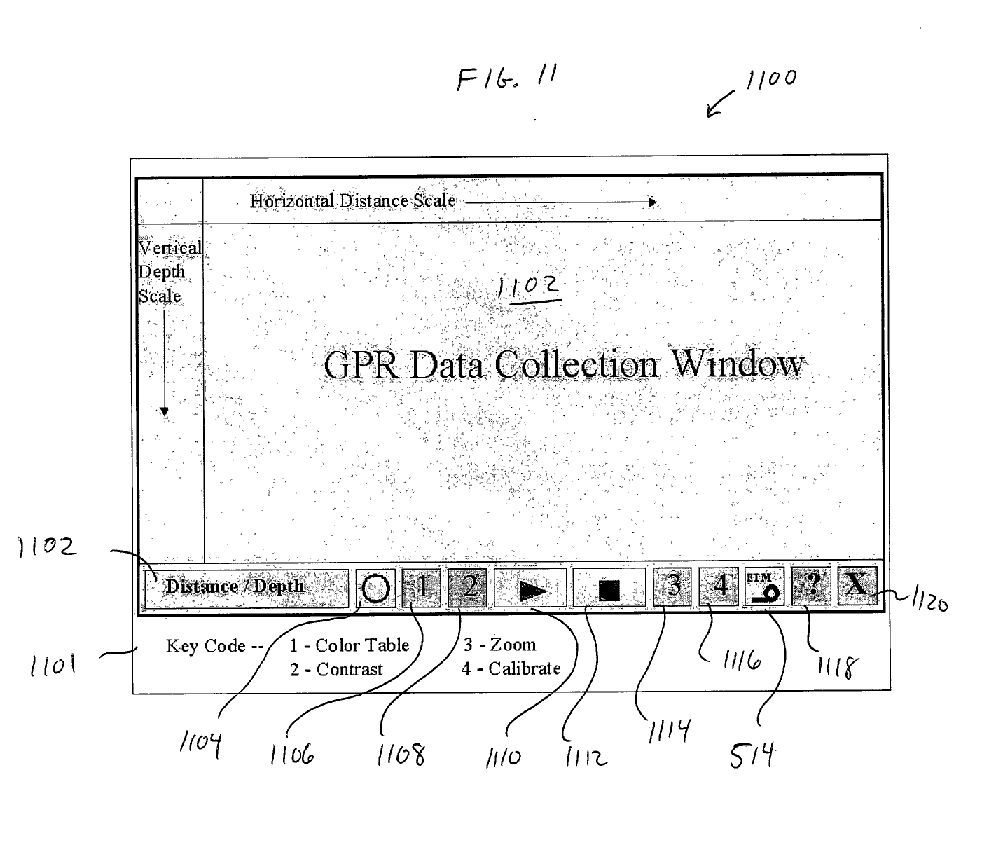

Selection of the run without saving button 416 causes the system to use the default settings for the dielectric constant (9), depth of exploration (10 ft or 3 m), and survey wheel to acquire data. There is no data collection setup and, following selection of the button 416, the operator proceeds directly to the run without saving data collection window, which is shown in FIG. 11.

The operator has access to a few basic functions as shown in Task Bar 4 1101 in FIG. 11, in addition to the backup cursor feature for target locating. Most of the buttons and functions shown in Task Bar 4 1101 operate in a manner previously discussed. The clear display button 1104 clears the display of the previous GPR survey data in preparation of the next set of data. The exit button 1120 returns the operator to the main menu page 400 shown in FIG. 4.

The following is a brief description of the run without saving data collection process according to an embodiment of the present invention. From the main menu page 400, the operator can select the run without saving icon 416 to proceed to the data collection window page 1100 of FIG. 11. Since the system will use the data collection default parameters, the operator should move the GPR sensor cart to the beginning of the survey line and select the start button 1110 to begin collecting GPR data. GPR data will begin to appear on the display 1102 and the distance/depth box 1102 will indicate the distance along the survey line. The operator may use the backup cursor at any time. While the backup cursor is displayed, the operator may calibrate the system or zoom in on a section of data.

At the end of the survey line, the operator can select the stop button 1112. GPR data will not be saved to the system's hard disk. To resume collecting data along another survey line, the operator clears the display using the clear display button 1104 and moves the GPR sensor cart to the beginning of another line before selecting the start button 1110 again. Between GPR lines, the operator may select the ETM button 514 to determine survey lengths, target locations, or the distance between to objects. To exit this window 1100, the operator can select the exit button 1120 to return to the main menu page 400 of FIG. 4.

With continued reference to FIG. 4, the data viewer button 418 allows the operator to review, analyze, and interpret GPR data that has just been acquired or previously recorded via a data viewer window. The data viewer window, configurations of which are shown in FIGS. 12 and 13, can also be accessed following the ‘save data’ dialog box once GPR data collection procedures have been completed. When invoked, a list of all previously collected GPR data files is presented, with an indication as to which files are single profiles (denoted with a ‘P’) or assembled grids (denoted with a ‘G’). The directory also indicates file size, date acquired, and whether a target file is associated with the GPR file, which is denoted with a ‘T’.

As can be seen in FIGS. 12 and 13, the data viewer window 1200 consists of two task bars 1202 and 1204. Task Bar 5 1202 is situated along the bottom of the window 1200 and controls the GPR data file appearance, file information, and output functions. Task Bar 6 1204, located along the right hand side of the window 1200, handles the calibration, processing, and mapping features of the window 1200 in order to enhance the interpretation of the GPR data. Other features of the data viewer window 1200 include a vertical depth scale 1206, a horizontal distance scale 1208, horizontal and vertical scroll bars 1207, 1209, and a mark bar 1210.

The horizontal distance scale 1208 is illustrated along the top of the data viewer display window 1201. The vertical depth scale 1206 is presented along the left hand side of the display window 1201. Adjacent to Task Bars 5 and 6 1202,1204 are horizontal and vertical scroll bars 1207,1209, respectively. The scroll bars 1207, 1209 allow the operator to cycle through the data in order to view different sections of the profile for interpretation and documentation purposes.

The mark bar 1210 is situated between horizontal distance scale 1208 and GPR data profile displayed in the GPR data display window 1201. The mark bar 1210 uses symbols to denote the start of separate GPR files in an assembled grid (squares), selected targets (circles), and depth calibration points (triangles). Other marks may be added if necessary or desired. The marks for selected targets are color-coded to conform to the Uniform Utility Color Code.

As described above, Task Bar 5 1202 provides functions for data review and Task Bar 6 1204 provides functions for data analysis and interpretation. The various task bar functions are indicated below:

Task Bar 5

1. Current Line Counter indicator 1220

2. Distance/Depth indicator 1222

3. New File button 1224

4. Open 2^{nd} File button 1226

5. Color Table button 1228

6. Color Contrast button 1230

7. Display Gain button 1232

8. File Information button 1234

9. Document button 1236

10. Help button 1238

11. Exit button 1240

Task Bar 6

1. Calibration button 1258

2. Signal Processing button 1256

3. Zoom button 1254

4. Target Selection button 1252

5. Map Viewer button 1250

6. ETM button 514

Many of the buttons and functions activatable via Task Bars 5 and 6 1202, 1204 operate in a manner previously discussed. The line counter indicator 1220 allows the operator to determine which survey line is currently being displayed in the data viewer display window 1201. This is especially helpful when viewing and interpreting an assembled grid file. Markers embedded in the mark bar 1210 denote the start of a new data set. The text in the line counter box 1220 typically displays line information as ‘Line X of N,’where ‘X’ is the current survey line and ‘N’ is the total number of survey lines. As a default, the ‘X’ value gets incremented when a line marker passes by the left hand edge of the display. If a stylus or mouse is used on the data profile, the ‘X’ value will update to indicate the appropriate survey line number corresponding to the selected location. In utility locating (profile) mode, the value of ‘X’ and ‘N’ will always be 1.

The distance/depth indicator 1222 functions include displaying the distance and depth coordinates of the mouse or stylus pen. Both X and Y distance coordinates are displayed in the distance/depth box 1222.

The new file button 1224 can be selected when the operator chooses to either collect a new data file or display a different data file. Upon selection, a dialog box will appear on the display with three features: 1) collect data button, 2) display data button, and 3) a file directory window if the display data button is selected. If the operator selects the collect data button, the program will return to the data collection setup page 500 of FIG. 5 where the filename, parameters, and/or grid can be defined for the new data file. If the display data button is selected, then the file directory window will populate with previously collected files. Upon selecting a file to display, the operator can activate the OK button and the file will be plotted in the data viewer display window 1201.

The open 2^{nd} file button 1226 allows the operator to display a previously collected GPR survey. This survey will be displayed in the lower half of the display window 1201 while the current data file is acquired in the upper half of the display window 1201. The command may be selected at any time. The intended use of the second file function is for a utility location and confirmation guide.

A GPR display gain button 1232 permits an operator to increase or decrease the signal amplitudes throughout the GPR profile. In some cases, the GPR signal amplitudes are diminished when different filters and/or functions are applied to the data. This button 1232 provides the operator with six (6) linear range gain parameters by which to enhance the GPR signal amplitudes as necessary. Selecting this button 1232 invokes a dialog box to the display indicating the available display gain selections. The five (5) gain selections available include the following multipliers: 0.5, 1.0 (default), 2.0, 4.0, and 8.0. Also available is a ‘user defined’ button in which the operator may design a unique linear gain filter for the data set.

The profile information button 1234 enables the operator to view information about the GPR data file. Selecting this button 1234 displays an information dialog box describing the data collection parameters, data processing parameters, and operator comments. Information pertaining to any selected targets is also listed.

The document button 1236 invokes a dialog box to the display offering the following options: 1) print GPR data to a file; 2) print GPR data to a printer; or 3) perform a screen capture of the data viewer display window 1201. Selection #1 writes the GPR data and file information to a file for later printing. Selection #2 prints the contents of the data viewer display window 1201 to a thermal printer or any other supported printers. If a printer is not connected to the system, an error message will appear. Selection #3 saves the current image in the data viewer display window 1201, including distance and depth scales, as a bitmap image. This image can then be incorporated into a report or presentation.

The help Information button 1238 provides helpful information on the button functions of Task Bars 5 and 6 1202, 1204, as well as other features of the data viewer window 1200. The exit button 1240 exits the data viewer window 1200 and returns the operator to the main menu page 400 of FIG. 4.

Referring now to the functions associate with Task Bar 6 1204, a calibration functions button 1258 provides access to a calibration function that allows the operator to perform either a hyperbolic curve match or depth calibration on a detected target. Calibration points are noted in the mark bar 1210 by a black triangle. This function is always active in the data viewer window 1200, but the operator should be careful when performing multiple calibration procedures.

The data calibration procedures can be used to better determine the dielectric constant of the subsurface material within the survey area. The data calibration procedures establish the propagation velocity of the electromagnetic waves at the location of the calibration. At system startup, the default dielectric constant value is 9 and represents an appropriate value for most GPR applications. On the data collection setup page 500 of FIG. 5, the default value populates the dielectric constant box 506, but the operator may adjust the value as desired. Also tagged to the dielectric constant box 506 is a button that, when selected, displays a listing of average dielectric constant values for various surface and subsurface materials. However, these values represent approximations to the actual site conditions. Therefore, the software offers two procedures to better define the dielectric constant value at the survey site: 1) depth calibration over a known target, and 2) hyperbolic curve matching. These procedures are discussed below.

The depth calibration procedure is available during the data collection procedures when the backup cursor is active (except in the utility mapping (grid) mode) and in the data viewer via the calibration functions button 1258 of Task Bar 6 1204, shown in FIGS. 12 and 13. A depth calibration can be performed as many times as necessary, but each calibration will change the dielectric constant value for the entire record. Therefore, the operator should be careful when performing multiple depth calibrations on a single data set.

An overview of the depth calibration procedure is as follows. During data collection, if the system detects a target of a known depth, the operator may backup over this target such that the backup cursor bisects the apex of the hyperbola. In the data viewer 1200, shown in FIGS. 12 and 13, the operator need only recognize which detected target represents the actual target of known depth. The operator can select the calibrate functions button 1258 from Task Bar 6 1204 and a calibration dialog box will appear on the display.

From the dialog box, the operator can select depth calibration to activate the appropriate software module. Following selection, the dialog box will disappear. The operator should then use the stylus or mouse to locate and select the apex of the hyperbola or top of the target of which the depth has been measured. Upon selection, a target depth dialog box will appear with the current depth displayed. The operator should adjust the depth to the measured known depth and select the OK button. The GPR profile will then be redisplayed incorporating the calibration value. A black triangle will be placed in the mark bar 1210 noting the calibration location.

Hyperbolic curve matching is a technique to precisely determine the propagation velocity of the electromagnetic waves in the subsurface. This calibration procedure is available during the data collection procedures when the backup cursor is active (except in the utility mapping (grid) mode) and in the data viewer 1200 via calibration functions button 1258. As with the depth calibration procedure, hyperbolic curve matching can be performed as often as necessary. For detailed mapping of buried targets, a hyperbolic curve match should be performed for each target to obtain the most accurate depth computations possible.

The following is an overview of the hyperbolic curve matching procedure. During GPR data collection, if the system detects a buried utility or point target, the operator may backup over the target such that the backup cursor bisects the apex of the hyperbola. In the data viewer 1200, the operator need only identify a hyperbola to the target of interest. At this point for either case, the operator can select the calibrate functions button 1258 from Task Bar 6 1204 and a calibration dialog box will appear on the display. From the dialog box, the operator can select hyperbola curve matching to activate the appropriate software module.

The operator should then use the stylus or mouse to accurately locate and select the apex of the hyperbola of interest. Upon selecting the hyperbola with the mouse or lifting the stylus, the following will occur. The calibration dialog box will disappear, a hyperbolic curve will appear over the selected target, and the hyperbola curve matching dialog box 1207 will appear, as is shown in FIG. 13. The hyperbolic trace that appears in the dialog box 1207 is based on the following parameters: the propagation velocity equals 0.328 funs (0.1 m/ns) and the dielectric constant value is 9.

The hyperbola curve matching dialog box 1207 lists parameters specific to this hyperbola, such as: 1) propagation velocity, 2) time (in nanoseconds), 3) target depth, and 4) estimated dielectric constant value. Other pertinent parameters may also be shown. The operator can adjust the hyperbolic curve up, down, and side to side with the arrow keys in the dialog box 1207 to precisely position the hyperbola over the target. The width of the hyperbola is adjusted to precisely match the target shape with the two remaining buttons. As the hyperbola is adjusted to fit the target, the dialog box 1207 parameters will automatically change as well. When the best curve fit is obtained, as shown in FIG. 13, the operator should select the OK button in the dialog box 1207 to lock in the parameter values. The GPR profile will then be redisplayed incorporating the calibration values. A black triangle will be placed in the mark bar 1210 noting the calibration location. The ‘X’ button 1240 may be selected at any time to cancel the calibration procedure.

A number of signal processing functions can be invoked using the signal processing button 1256 shown in FIGS. 12 and 13. The signal processing functions allow the operator to enhance the GPR data in order to better detect buried utilities. Conventional systems are operated by scanning the area of interest and interpreting the GPR data image. Target images are sometimes difficult to detect without additional signal processing. The signal processing functions of the present invention provide for the addition of a compliment of signal processing algorithms to allow the operator to enhance the data image and thereby make more accurate target interpretations.

Conventional GPR systems require the operator to exit the data collection software to access separate data processing programs to enhance the data to allow better interpretation of the data. Other systems require the operator to transfer data to a different computer platform in order to perform data processing. According to the present invention, a number of signal processing functions is made available to the operator within the utility mapping/locating software.

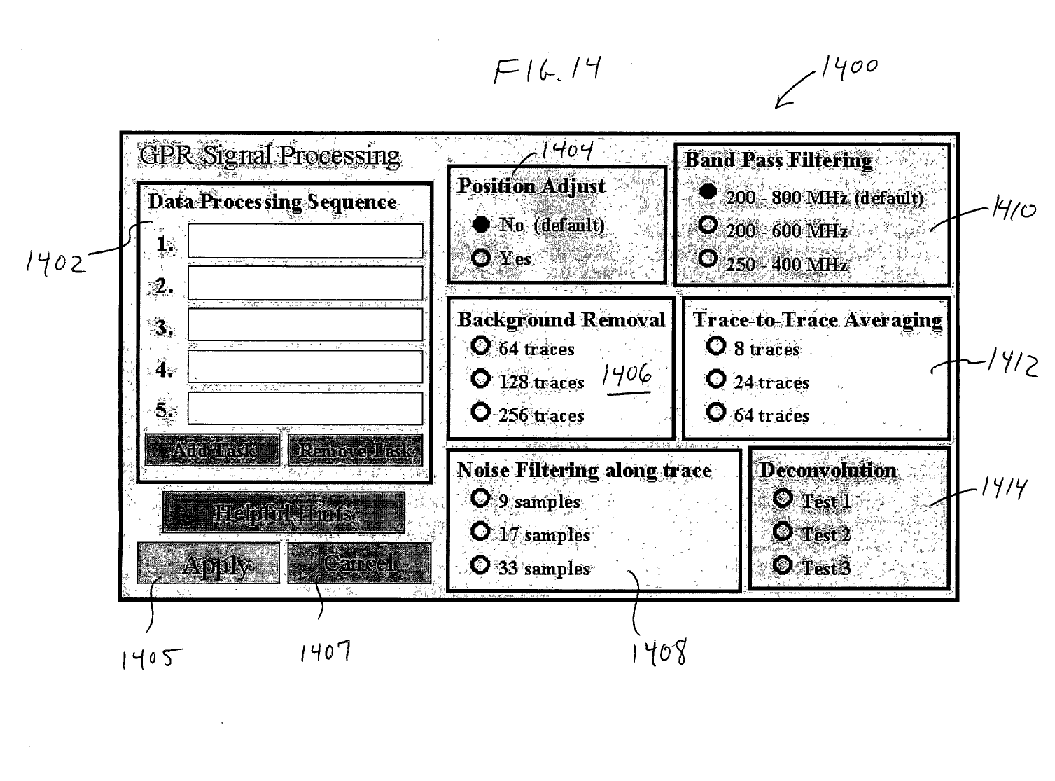

With a GPR file present in the data viewer display window 1201, the signal processing functions are accessed by activation of the signal processing button 1256. When the button 1256 is selected, a signal processing menu page 1400, as shown in FIG. 14, appears on the display with the active functions highlighted and inactive functions ghosted. The available signal processing functions include the following:

1. Position Adjust via window 1404

2. Background Removal via window 1406

3. Band Pass Filtering via window 1410

4. Noise Filtering along each trace via window 1408

5. Trace-to-Trace Averaging via window 1412

6. Deconvolution via window 1414

Each of these functions has several parameter selections with which to apply to the data. On the left-hand side of the signal processing menu page 1400 is the data processing sequence box 1402. This box 1402 displays the signal processing tasks selected and the order by which to apply the tasks to the data. A maximum of five (5) tasks can be applied to any given data set according to this embodiment. Tasks may be added to the data processing sequence list 1402 by selecting the ‘add task’ button and tasks may be removed with the ‘remove task’ button. The processing tasks are performed on the original raw GPR data set in the order listed. A separate display gain button is available to adjust the viewability of the GPR data set. One or more of the processing algorithms can be performed simultaneously and the data processing function can be accessed as many times as necessary to enhance the GPR data record.

The following is a brief discussion of each data processing task and associated parameters. It is sometimes necessary to vertically adjust the position of the GPR profile such that the ground surface reflection corresponds to ‘Depth =0’. To adjust the position, the operator can select ‘Yes’ in the Position Adjust dialog box 1404 shown in FIG. 14.

The background removal function, when activated via window 1406, uses a boxcar filter to perform a running average along the complete GPR profile, and is typically used to remove or minimize linear features. A portion of the data profile is determined by a window length about a central GPR scan. The window length is defined by one of the three parameter selections in the background removal dialog box 1406. All scans within the defined window are averaged using a boxcar filter (all scans are weighted equally) and the averaged result is subtracted from the central waveform. The resulting waveform is then plotted in place of the central waveform. The defined window then moves to the adjacent scan and the process continues. This is done along the entire length of the GPR profile.

Three settings are presented in the band pass filtering dialog box 1410. The default value, 200 to 800 MHz, is the band pass filter currently applied to the GPR data during acquisition. Two other band pass settings are available to assist in removing any low frequency banding in the data or high frequency noise. The band pass filtering function is generally applied once.

The noise filtering along each trace function, activated via window 1408, uses a boxcar filter to perform a running average along the length of each scan in an effort to minimize any signal noise. A section of a particular scan is determined by a window length centered about a trace sample point. The window length is defined by one of the three parameter selections in the noise filtering dialog box 1408. All signal amplitudes within the defined window are averaged using a boxcar filter and the averaged result is plotted at the position of the central sample point. The defined window then moves down the trace to the adjacent sample point and the averaging continues. This process continues along the entire length of the scan. More of the original waveform information will be maintained when the window length is its shortest.

The trace-to-trace averaging function, activated via window 1412, uses a boxcar filter to perform a running average along the complete GPR profile and is typically used to enhance linear features. A portion of the data profile is determined by a window length about a central GPR scan. The window length is defined by one of the three parameter selections in the trace-to-trace averaging dialog box 1412. All scans within the defined window are averaged using a boxcar filter (all scans are weighted equally) and the averaged result is plotted at the position of the central waveform. The defined window then moves to the adjacent scan and the averaging continues. This process continues along the entire length of the GPR profile.

Deconvolution is a filtering method used to minimize reflection multiples or ‘ringing’ from the GPR data set in order to better visualize data signatures deeper in the profile. This function can also be used to restore the vertical resolution of the radar data in an effort to better resolve reflection horizons, hyperbolic signatures, and closely spaced layers and targets. In the deconvolution dialog box 1414, three possible selections are noted and referred to generically as Tests 1 through 3. Each ‘test’ will have different parameters in order that a ‘test’ will correspond to specific types of survey conditions. Repeated testing is typically required with these settings to determine a robust set of deconvolution settings for a wide range of GPR data.

An overview of the signal processing process is as follows. The data viewer window 1200, such as that shown in FIGS. 12 and 13, displays the recently acquired GPR data file or a previously acquired data file. It should be noted that a backup copy of the original raw GPR data file should be saved to the hard disk. To initiate any signal processing functions on the displayed data set, the operator can select the signal processing button 1256 along Task Bar 6 1204. With this action, a backup copy of the currently displayed data is saved to the hard disk and the signal processing page 1400 of FIG. 14 appears in the data viewer window 1200. If entering the signal processing function for the first time, the data processing sequence list 1402 will be empty, and all signal processing functions should be active. However, as tasks are added to the data processing sequence 1402, some of the functions may become inactive. During subsequent visits to the signal processing page 1400, the data processing sequence 1402 will list which tasks have been incorporated into the current data viewer image. This list may be modified as necessary to enhance the data. A maximum of five (5) data processing tasks may be applied to the GPR data set at any time.

When the data processing sequence is set, the operator should select the ‘Apply’ button to process the data. The processing tasks are performed on the original raw GPR data set. Selection of the ‘Cancel’ button returns the operator to the data viewer window 1200 without any signal processing algorithms being applied to the GPR data. During data processing, a gas gauge image appears on the display indicating the computer is processing the data.

When complete, the processed data appears in the data viewer display window 1201 and the operator may either ‘Accept’ or ‘Decline’ the resultant file upon review. If the processed data is accepted, the newly created, processed data is saved to a file and becomes the current data viewer image. The previous file is deleted, unless the previous file was the original GPR data. If the newly created file is declined, the file is discarded and the previous image is returned to the data viewer display. In the data viewer 1200, the signal processing button 1256 may be accessed as often as necessary to enhance the file image for better interpretation.

Also available from Task Bar 6 1204 in FIGS. 12 and 13 is a zoom feature. The operator can select the zoom button 1254 to use the stylus or mouse in order to define a window of GPR data to enlarge for better data interpretation. The selected data will be enlarged by a factor of 2 times the original and the center of the selected window will be placed at the center of the data viewer display window 1201. This function may be used twice to effectively enlarge an area of GPR data a factor of 4 times the original size. If the data profile is enlarged, the horizontal and vertical scroll bars 1207, 1209 (if not already present) will appear in the data viewer display window 1201 to allow the operator to view all sections of the GPR profile.

A number of functions are made available to the operator via activation of the target selection button 1252 of the data viewer 1200 shown in FIGS. 12 and 13. The system software includes functions to select, label, and mark detected targets. The target selection button 1252 is used to determine and record the location and depth of targets detected during surveying. When selected, the operator uses the mouse arrow or stylus to locate the apex (top) of a target. The surface distance (both X and Y coordinates) and subsurface depth are displayed in the distance/depth box 1222. Lifting the stylus or clicking the mouse brings up the targets dialog box where the most appropriate label is selected for the target. A drop down menu provides for choosing target labels that are not utilities, such as vaults, trenches, and pavement joints, for example.

As was discussed above, the mark bar 1210 is situated between horizontal distance scale 1208 and the GPR data profile presented in the data viewer display window 1201. The mark bar 1210 uses symbols to denote the start of separate GPR files in an assembled grid (squares), selected targets (circles), and depth calibration points (triangles). Other marks may be added if necessary. The marks for selected targets are color-coded to the Uniform Utility Color Code.

Once a label is selected, the position values, depth, and target label are written to an ASCII file unique to the current GPR data file. A color-coded circle with respect to the Uniform Utility Color Codes is illustrated in the mark bar 1210 of the data viewer 1200 at the noted distance. This circle indicates that the displayed hyperbola has been selected in order to minimize target duplication. The operator may either continue to select targets until all targets are labeled or exit the function. The information recorded (X distance, Y distance (if any), depth, target label) are used to generate utility cross-sections and plan maps in the map viewer function discussed below for better interpretation of the GPR data set.

A map viewer function can be activated by use of the map viewer button 1250. The map viewer function uses the saved target selection information to generate utility cross-section plots and plan view maps. The map viewer function is only active if the GPR data file was saved to the hard disk following data collection. If the GPR data was saved, the map viewer function is then only active if utilities or objects have been selected using the target selection function.

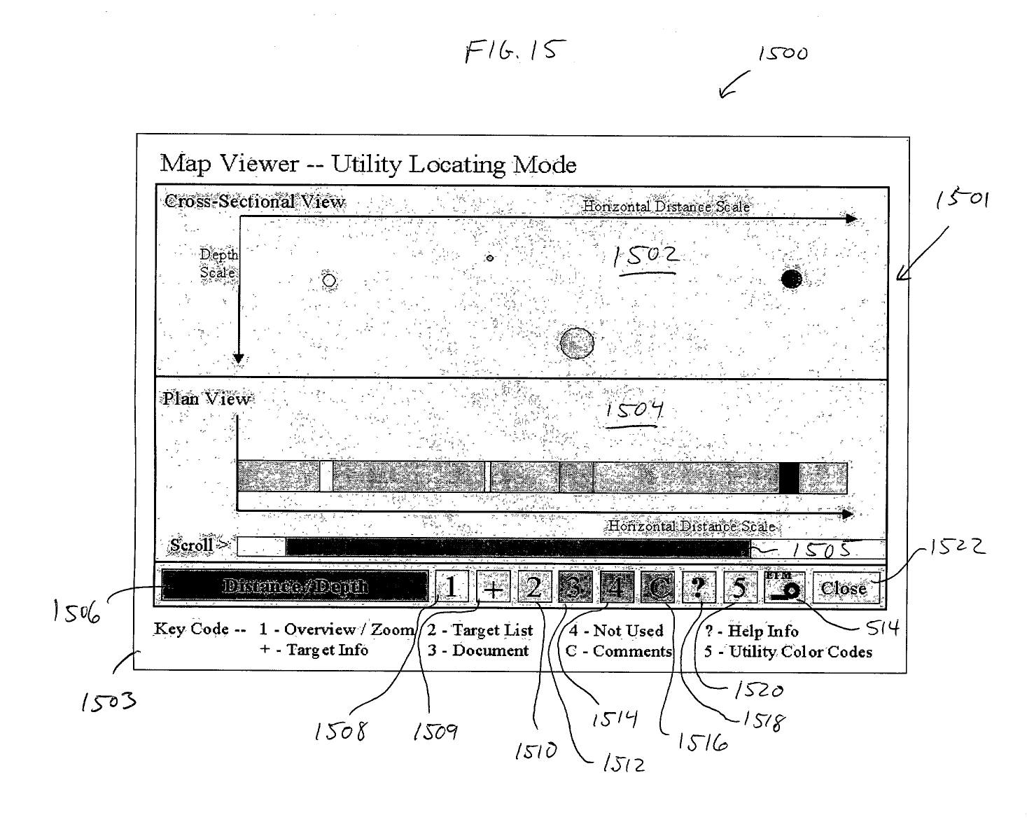

The map viewer serves a dual role depending on whether the data was collected in the utility locating mode or utility mapping mode. As is best seen in FIG. 15, in the utility locating mode, the map viewer button 1250 displays a cross-sectional view of the detected (selected) targets in the upper two-thirds 1502 of the display 1501 in order to illustrate the distance to and depth of the detected utilities and targets. In the lower third 1504 of the display 1501, a plan view diagram is presented.

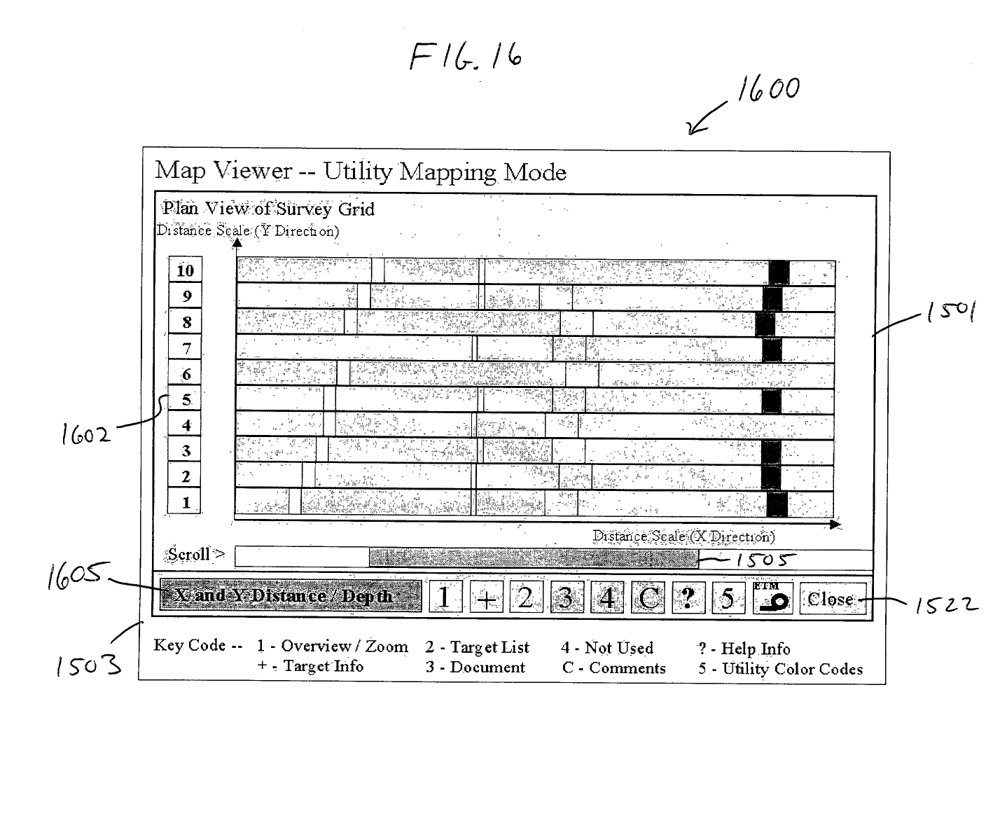

In the utility mapping mode, and as shown in FIG. 16, the map viewer function displays a plan view grid map of the detected (selected) targets compiled from each survey line comprising the grid. The plan map illustrates the layout, orientation, and spatial relationship between detected targets. The X and Y distance and depth information is presented in an X/Y distance/depth box 1605 on the task bar 1503. The targets are color-coded with respect to the Uniform Utility Color Code guide and non-utility targets are given a generic color such as black, white, or light blue. A button bar 1602 on the left hand side of the plan map corresponds with the individual survey line numbers (e.g., line numbers 1 through 10).

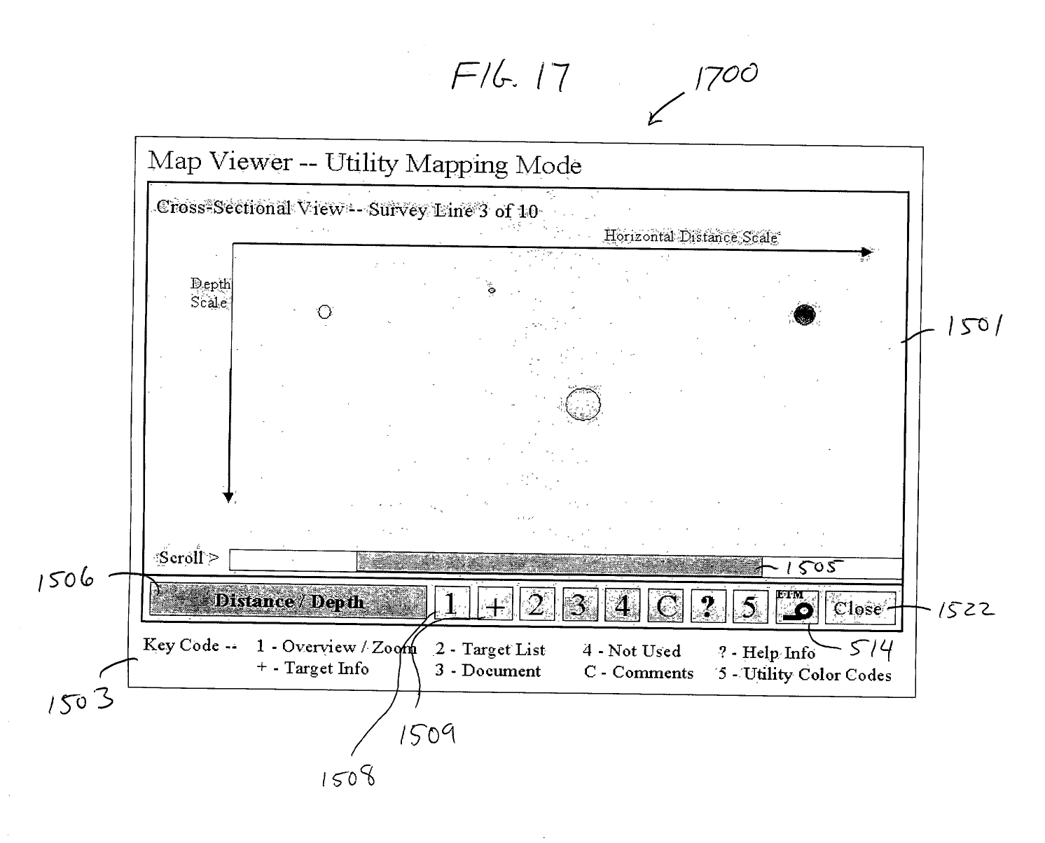

Selecting a particular button on the button bar 1602 will bring up a cross-sectional view of the detected (selected) targets, as is shown in FIG. 17. In the depiction of FIG. 17, the cross-sectional view of detected (selected) targets for survey line 3 of 10 is shown, which resulted from selection of button 3 on the button bar 1602 of FIG. 16. Depth information may be obtained from this plot. From this point, the close button 1522 of FIG. 17 returns the operator to the plan map display of FIG. 16. Selecting the close button 1522 of FIG. 16 returns the operator to the GPR data profile display. The operator may toggle between the plan map display and a cross-sectional display as often as necessary to understand target orientations and depths.

In either the utility locating mode or utility mapping mode, the target representations are color-coded to the Uniform Utility Color Code guide. In any of the plots, selecting a color-coded target with the stylus or mouse will display the target label on the plot and the distance and depth information in the associated distance/depth box. A horizontal scroll bar 1505 allows the operator to easily cycle through the entire graphical display. It is noted that once a target or targets have been selected on the data viewer page 1200, the operator may toggle in and out of the map viewer window 1501 as often as necessary to understand and interpret the GPR data. For the default presentation, the horizontal distance scale is the same length as the GPR data profile. An overview/zoom button 1508 is available to show the complete map viewer illustration. While viewing the map viewer display, the operator can use the ETM button 514 to confirm the distance between target locates or measure target distances from known reference points.

By way of example, GPR data is typically collected in scans or “rows” as the scanning apparatus is pulled across the topography. For example, if the width of an area to be scanned is 10× the width of the apparatus, there will be 10 rows of data. Conventional systems are operated by scanning the entire area, e.g., completing all 10 rows. If a string of data images are presented, the relationship between the detected target signatures is not intuitive. The present invention provides a screen wherein the operator can select the target signatures and then toggle from the “raw” data type of screen previously described to a “bird's eye” view type of screen, wherein the location of the selected targets are displayed and labeled.

As such, the relative locations from one row to the next will be evident. Cross-sectional views are also generated, wherein one row is displayed and the relative depth of the selected targets is displayed. Toggling between images may be enabled anytime during post data collection processing. This technique, applied to a grid of GPR data, has many advantages, particularly in improving the accuracy of the data interpretation. For example, if the operator is able to detect four utilities along rows 5 and 7, but only 3 targets along row 6, this information would allow the operator to go back and review row 6 in a specific location. In row 6, the 4^{th} target may have shown up very faintly or may have simply been missed.

The functions and buttons of Task Bar 7 1503 shown in FIGS. 15-17 offer the operator various options for viewing and understanding the target maps. A brief summary of the task bar functions and buttons is provided as follows. The distance/depth box 1506 displays the distance and depth coordinates of a selected target in the map viewer window 1501. The overview/zoom button 1508 toggles the operator between two different map viewer displays.

The default map viewer display illustrates the plan map and/or utility cross-section (FIG. 15) using the same horizontal distance scale as that of the GPR data profile in the data viewer window. The operator can use the horizontal scroll bar 1505 to view all of the map viewer images. Selecting the overview/zoom button 1508 illustrates the complete plan map and/or utility cross-section in the map viewer window 1501. This allows the operator to better view the orientation and layout of all detected targets. It is noted that if the survey line length is very long, the overview display may be difficult to interpret.

Th target Information button 1509 is used to select a target in order to display the label, depth, and location of targets illustrated in the map viewer window 1501. The target Information feature allows the operator to use a mouse arrow or stylus to select the target image. When a target is selected, the target label will appear next to the object. The position and depth are displayed in the distance/depth box 1506. This button 1509 is always active and may be used as many times as desired.

The target list button 1510 brings up a dialog box listing all targets selected for the GPR data profile. The information presented is the target label, X distance, Y distance, and depth.

Selecting the document button 1512 brings a dialog box to the display offering the following options: 1) Print GPR data to a file, 2) Print GPR data to a printer, or 3) Perform a screen capture of the data viewer window. Selection #1 writes the GPR data and file information to a file for later printing. Selection #2 prints the contents of the data viewer display to a thermal printer or any of the other WINDOWS NT supported printers. If the printer is not connected to the system, an error message will appear. Selection #3 saves the current image in the data viewer window, including distance and depth scales, as a bitmap image. This image can then be incorporated into a report or presentation.

Upon activation of the comments button 1516, the operator may enter additional comments to the comments page concerning the target cross-section and/or utility plan map. These comments may include utility layout, depths, and data interpretations. Help information provides helpful information on the button functions of Task Bar 7 1503, as well as other features of the map viewer window, via help button 1518.

The utility color codes button 1520 brings up a dialog box to the display illustrating the Uniform Utility Color Codes. The ETM button 514 accesses the electronic tape measure as previously discussed. The close button 1522 returns the operator to the data viewer window 1200 of FIGS. 12 and 13, with the current GPR data profile displayed.

With further reference to FIG. 16, in the utility mapping mode, target information is selected in the data viewer window along the assembled GPR grid profile consisting of the number of GPR survey lines specified in the grid setup page of FIG. 8 and surveyed in the utility mapping data collection window. Once target information has been saved via the target selection function, the map viewer button may be used to display a plan map compiled from each survey line.

Selecting the map viewer button in the data viewer window will display a plan view grid map of the selected (detected) targets to this point. As is intended in FIG. 16, colored segments are presented that represent selected hyperbolas along each of 10 survey grid lines. The individual survey lines are noted by the numeric button bar 1602 along the left-hand side of the plan map and the X and Y distance scales are as shown. Selecting any of the numeric buttons 1602 will display the corresponding cross-sectional view of the selected (detected) targets along that survey line. An example of this display is shown in FIG. 17, which corresponds to the hypothetical survey line 3.

It is noted that the numeric button bar 1602 and survey lines may be inverted depending on the grid orientation specified in the grid setup page of FIG. 8. After enough targets are selected, the plan view map can illustrate the orientation and location of targets detected with the GPR system. The overview/zoom button 1508 is available to show the complete map viewer plan map illustration. For example, the gas line (yellow is intended color) is shown to trend diagonally across the grid, whereas the telephone line (orange is intended), sewer line (green is intended), and water line (blue is intended) are perpendicular to the survey lines. Note that if the GPR system does not start at the same base line each time, the utility lines may not form a straight line as shown.

With continued reference to FIG. 16, gaps in the mapped utility lines denote missing target information. Selecting the target info button 1509 allows the operator to select a colored square with the mouse or stylus. The X and Y distance and depth information of the target will appear in the X and Y distance/depth box 1605 on the task bar 1503. The target label will appear on the display identifying the target. The entire list of targets may be viewed using the target list button 1510. While viewing the map viewer plan map display, the operator can use the ETM button 514 to confirm the distance between target locates or measure target distances from known reference points. From the map viewer, the operator selects the close button 1522 to return to the GPR data profile in the data viewer window.

Referring in greater detail to FIG. 17, the cross-sectional view shown in FIG. 17 presents the location as well as depth of the selected targets along an individual survey line. The selected targets are color-coded according to the Uniform Utility Color Code guide and non-utility targets will be given a generic color such as black, white, or light blue. Using the target info button 1509, the operator may use the mouse or stylus to select a target symbol to display the target label on the plot and the distance and depth information in the distance/depth box 1506 on Task Bar 7 1503. For presentation, the horizontal distance scale is the same length as the GPR data profile and, therefore, the operator may need to use the scroll bar 1505 to view the entire plot. An overview/zoom button 1508 is available to show the complete map viewer illustration.

Particularly useful information obtainable from the cross-sectional plots is the depth relationships of the detected targets. While viewing the map viewer display, the operator can use the ETM button 514 to confirm the distance between target locates or measure target distances from known reference points. After reviewing the cross-section diagram, the close button 1522 returns the operator to the map viewer plan map display. The operator may toggle between the plan map display and a cross-sectional display as often as necessary to understand target orientations and depths.

Returning to the main menu page 400 of FIG. 4, the file management button 420 is used to remove GPR data files from the computer. Selection of the file management button 420 displays a window listing the file names currently in memory. Placing a ‘check’ mark next to a file will earmark that file for deletion. The operator is also able to select a group or block of files for removal. Tapping the remove button will delete the files.

The help button 422 provides assistance on any selected item on Task Bar 1 404 of the main menu page 400. A description of equipment use, survey techniques, and help issues on system operation are also provided. An about button 424 lists the current software versions for both the computer control unit and the antenna (e.g., Model XYZ, 300 MHz antenna).

A computer assisted method for collecting and displaying GPR data according to the present invention may thus be effected, for example, by a processor implementing a sequence of machine-readable instructions. These instructions may reside in various types of signal-bearing media. In this respect, another embodiment of the present invention concerns a programmed product which includes a signal-bearing medium embodying a program of machine-readable instructions, executable by a digital processor to perform method steps to effect the GPR data collection and displaying procedures of the present invention. The signal-bearing media may include, for example, random access memory (RAM) provided within, or otherwise coupled to, the processor.

Alternatively, the instructions may be contained in other signal-bearing media, such as one or more magnetic data storage diskettes, direct access data storage disks (e.g., a conventional hard drive or a RAID array), magnetic tape, alterable or non-alterable electronic read-only memory (e.g., EEPROM, ROM), flash memory, optical storage devices (e.g., CDROM or WORM), signal-bearing media including transmission media such as digital, analog, and communication links and wireless, and propagated signal media. In an illustrative embodiment, the machine-readable instructions may constitute lines of compiled “C” language code or “C++” object-oriented code.

The systems and methods for collecting, processing, and displaying GPR data according to the present invention may be employed to perform subsurface imaging for purposes of detecting buried objects, utilities, obstacles, and geologic strata. Various techniques for detecting subsurface structures and objects and for characterizing subsurface geology which may be employed in combination with the present invention are disclosed in commonly assigned U.S. Pat. Nos. 5,720,354; 5,904,210; 5,819,859; 5,553,407; 5,704,142; 5,659,985; 6,315,062; 6,308,78; and 6,389,360; and U.S. Ser. No 09/727,356 (1125.34USU1), all of which are hereby incorporated herein by reference in their respective entireties. An exemplary approach for detecting an underground object and determining the range of the underground object is described in U.S. Pat. No. 5,867,117, which is hereby incorporated herein by reference in its entirety.

It will, of course, be understood that various modifications and additions can be made to the preferred embodiments discussed hereinabove without departing from the scope of the present invention. Accordingly, the scope of the present invention should not be limited by the particular embodiments described above, but should be defined only by the claims set forth below and equivalents thereof.

What is claimed is:

1. A portable system for detecting underground features, comprising:
an electromagnetic detection unit;
a processor that receives detection data from the detection unit;
a user interface device coupled to the processor; and
a display coupled to the processor, the processor, in response to a user input received via the user interface device, cooperating with the display to selectively present one or both of a cross-sectional view and a plan view of the underground features detected by the detection unit.

2. The system of claim 1, wherein the plan view comprises a plan view grid mapping of the underground features.

3. The system of claim 2, wherein each survey line of the plan view grid is associated with a button presented on the display, further wherein activation of a particular button causes the processor to display a cross-sectional view of underground features detected along the survey line associated with the particular button.

4. The system of claim 2, wherein the plan view indicates an orientation of the detected underground features and a spatial relationship between the detected underground features.

5. The system of claim 1, wherein the cross-section view of the underground features indicates a depth of each of the detected underground features and indicates a distance to each of the detected underground features relative to a reference point.

6. The system of claim 1, wherein the plan view of the detected underground features indicates a distance to each of the detected underground features relative to a reference point.

7. The system of claim 1, wherein each of the detected underground features is denoted by a symbol having a particular shape and a particular color respectively corresponding to a particular detected underground feature.

8. The system of claim 1, wherein each of the detected underground features is denoted by a symbol, the symbols arranged within a mark bar in spatial relationship relative to each of the detected underground features, further wherein each of the symbols within the mark bar is representative of a corresponding detection data file.

9. The system of claim 1, wherein each of the detected underground features is denoted by a symbol having a color conforming to a Uniform Utility Color Code.

10. The system of claim 1, wherein an electronic tape measure device is activated by user selection of an ETM button on the display via the user interface device, the ETM device, respectively activated and deactivated via start and stop buttons, activatable to measure a distance over a ground surface.

11. The system of claim 10, wherein the ETM device is activated by user selection of the ETM button during times when the processor is not receiving GPR data from the detection unit.

12. The system of claim 1, wherein an estimate of detection unit signal penetration depth is presented on the display.

13. The system of claim 1, wherein the display comprises a touch screen display, and the user interface device comprises one or both of a stylus and a mouse.

14. The system of claim 1, wherein the detection unit comprises a ground penetrating radar.

15. The system of claim 1, wherein the system comprises a cart for transporting the electromagnetic detection unit, processor, user interface device, and display along a ground surface.

16. The system of claim 1, wherein the system is mounted on a hand-held locator frame.

17. A method of detecting underground features, comprising:
transmitting a source electromagnetic signal into a subsurface while moving relative to a survey line;
receiving a reflected electromagnetic signal from the subsurface while moving relative to the survey line;
detecting underground features using the reflected electromagnetic signal; and
selectively displaying one or both of a cross-sectional view and a plan view of the detected underground features.

18. The method of claim 17, wherein transmitting, receiving, and detecting are repeated for each on N survey lines, the N survey lines defining a survey grid, wherein selectively displaying comprises displaying a plan view comprising a plan view grid mapping of the underground features for the N survey lines.

19. The method of claim 18, wherein each of the N survey lines is associated with a displayed button, further wherein activation of a particular displayed button causes displaying of a cross-sectional view of underground features detected along the survey line associated with the particular button.

20. The method of claim 18, wherein the plan view indicates an orientation of the detected underground features and a spatial relationship between the detected underground features.

21. The method of claim 17, wherein the cross-section view of the underground features indicates a depth of each of the detected underground features and indicates a distance to each of the detected underground features relative to a reference point.

22. The method of claim 17, wherein the plan view of the detected underground features indicates a distance to each of the detected underground features relative to a reference point.

23. The method of claim 17, wherein each of the detected underground features is denoted by a symbol having a particular shape and a particular color respectively corresponding to a particular detected underground feature.

24. The method of claim 17, wherein each of the detected underground features is denoted by a symbol having a color conforming to a Uniform Utility Color Code.

25. The method of claim 17, further comprising electronically measuring a surface distance in response to user selection of an electronic tape measure (ETM) via an ETM button.

26. The method of claim 17, further comprising estimating and displaying source electromagnetic signal penetration depth.

27. The method of claim 26, wherein the source electromagnetic (EM) signal penetration depth is estimated by subtracting temporally separated reflected EM signal components where the reflected EM signal components exceeds a predetermined interval either side of zero.

28. A computer readable medium embodying program instructions for detecting underground features, comprising:
transmitting a source electromagnetic signal into a subsurface while moving relative to a survey line;
receiving a reflected electromagnetic signal from the subsurface while moving relative to the survey line;
detecting underground features using the reflected electromagnetic signal; and
selectively displaying one or both of a cross-sectional view and a plan view of the detected underground features.

29. The medium of claim 28, wherein transmitting, receiving, and detecting are repeated for each on N survey lines, the N survey lines defining a survey grid, wherein selectively displaying comprises displaying a plan view comprising a plan view grid mapping of the underground features for the N survey lines.

30. The medium of claim 29, wherein each of the N survey lines is associated with a displayed button, further wherein activation of a particular displayed button causes displaying of a cross-sectional view of underground features detected along the survey line associated with the particular button.

31. The medium of claim 29, wherein the plan view indicates an orientation of the detected underground features and a spatial relationship between the detected underground features.

32. The medium of claim 28, wherein the cross-section view of the underground features indicates a depth of each of the detected underground features and indicates a distance to each of the detected underground features relative to a reference point.

33. The medium of claim 28, wherein the plan view of the detected underground features indicates a distance to each of the detected underground features relative to a reference point.

34. The medium of claim 28, wherein each of the detected underground features is denoted by a symbol having a particular shape and a particular color respectively corresponding to a particular detected underground feature, at least some of the symbols having a color conforming to a Uniform Utility Color Code.

35. The medium of claim 28, further comprising electronically measuring a surface distance in response to user selection of an electronic tape measure (ETM) via an ETM button.

36. The medium of claim 28, further comprising estimating and displaying source electromagnetic signal penetration depth.
